(19) United States
(12) Patent Application Publication
(10) Pub. No.: US 2013/0316650 A1
(43) Pub. Date: Nov. 28, 2013

(54) MOUNTING APPARATUS, METHOD, AND SYSTEM FOR SHORT-RANGE WIRELESS COMMUNICATIONS

(71) Applicant: LIST FORWARD, LLC, Redmond, WA (US)

(72) Inventor: Ryan Preston REED, Woodinville, WA (US)

(73) Assignee: LIST FORWARD, LLC, Redmond, WA (US)

(21) Appl. No.: 13/681,204

(22) Filed: Nov. 19, 2012

Related U.S. Application Data
(60) Provisional application No. 61/652,184, filed on May 26, 2012.
(60) Provisional application No. 61/723,760, filed on Nov. 7, 2012.

(51) Int. Cl. H04B 7/24; F16M 13/02

(52) U.S. Cl. CPC H04B 7/24; F16M 13/02
USPC 455/41.2; 248/205.1

(57) ABSTRACT

A mounting apparatus enables a near field communication (NFC) tag, radio frequency identification (RFID) tag, bar code or other machine-readable symbol, or other information-storage element located on the mounting apparatus to be read/interrogated by a user's wireless communication device, such as for example to obtain business card information. A system and method is also disclosed that connects consumers with retail employees on a social network and allows for consumers to collect and store contact information of retail establishments and its employees, within a retail environment. Communication is provided between consumers and retail professionals and consumers may also bookmark, manipulate, or share contact information, provide feedback and interact; and store professionals contact information locally or remotely. Retail business owners may also present an electronic list of a plurality of its employees and their contact information thereby providing the consumer a choice to save the contact information locally or remotely. Consumers may connect with a plurality of employees within an out of home environment.

### CROSS REFERENCE TO RELATED APPLICATIONS

The present application claims the benefit of and priority under 35 U.S.C. §119(e) to U.S. Provisional Patent Application Ser. No. 61/652,184, entitled “BUSINESS CARD DISPLAY, LISTING AND BOOKMARKING SYSTEM,” filed May 26, 2012, and to U.S. Provisional Patent Application Ser. No. 61/723,760, entitled “BUSINESS CARD DISPLAY, LISTING AND BOOKMARKING SYSTEM,” filed Nov. 7, 2012, both of which are incorporated herein by reference in their entireties.

### TECHNICAL FIELD

The present disclosure generally relates to physical mounting devices, and in particular but not exclusively, relates to a physical mounting apparatus that may be used to facilitate wireless communication between a wireless user device and a tag and/or a machine-readable symbol of the mounting apparatus.

The present disclosure is also in the technical field of computer technology. More particularly but not exclusively, the present disclosure is in the technical field of software programming, fixed and wireless networking, mobile technologies, radio frequencies, bar code technologies, scanning technologies and other Internet related technologies. More particularly but not exclusively, the present disclosure is in the technical field of near field communication and bar code scanning relating to professional profiles, business cards, business card holders, social networking and social bookmarking.

### BACKGROUND INFORMATION

Today, there is a limited way for consumers to obtain contact information from sales professionals in a retail environment. When visiting retail business locations, a consumer may want to obtain the contact information of the business or its employees. Generally, paper business cards are present at the retail counter, and the consumer would take one card for the business or a specific employee, which they would then file or input into an electronic database. Alternatively, the consumer would ask for the information and would write it down on paper or would type it into a mobile device.

Currently, there is technology available that allows contact information to be passed over near field radio frequencies (using near field communication or NFC technology), which can be in the form of stickers, posters, NFC tags embedded into business cards or other devices or items having an NFC tag. NFC and Bluetooth radios are being integrated into consumer smartphones, which allow consumers to read information that is stored within the NFC or Bluetooth chip. Contact information relating to businesses and employees are currently being stored on NFC chips/tags and being shared between consumers and employees at conventions and trade shows.

In addition to NFC and Bluetooth technology, bar codes (including QR Codes or scan tags) and other machine-readable symbols are being used to hold information that can be passed to consumers that have applications on their smartphones that can scan and read the bar codes.

Alternatively, consumers with smartphones can use applications that use global positioning system (GPS) location to receive the business location and contact information when they are physically near a retail establishment.

Despite these available technologies, the conveyance of information to the consumer/user remains largely inefficient or ineffective in many situations.

### BRIEF SUMMARY

The present disclosure is a system and method for connecting consumers with retail employees on a social network and allowing for consumers to collect and store contact information of retail establishments and its employees, within a retail environment. The present disclosure allows for communication between consumers and retail professionals and may allow consumers to bookmark, manipulate, or share contact information, provide feedback and interact; and store professionals contact information locally or remotely. The present disclosure allows retail business owners to present an electronic list of a plurality of its employees and their contact information providing the consumer a choice to save the contact information locally or remotely. Further, the present disclosure allows consumers to connect with a plurality of employees within an out of home environment.

According to one aspect, an apparatus comprises:

a pad; and

at least one clip coupleable to the pad,

wherein the pad has an information-storage element that is responsive to a wireless signal from a mobile device to provide information stored in the information-storage element to the mobile device,

wherein the pad is attachable by the clip to a holder that contains physical literature that provides at least some of said information in printed form, and

wherein the pad includes a first portion that is inclined at an angle to improve communication between the information-storage element and the mobile device in view of an angle of incidence of the wireless signal on the pad and in view of an orientation of the mobile device as held by a user over the pad.

In one embodiment, the first portion is inclined at the angle such that the wireless signal has a substantially normal angle of incidence on a face surface of the pad.

In one embodiment, the information-storage element includes at least one or more of a near-field communication (NFC) tag, a radio frequency identifier (RFID) tag, a bar code, a QR code, or a Bluetooth device.

In one embodiment, the information-storage element is affixed on a face surface of the pad as a sticker, printed on the face surface of the pad, or integrated within a material of the pad.

In one embodiment, the apparatus further comprises at least one bracket, and wherein the pad includes at least one bracket receptacle shaped to receive the bracket.

In one embodiment, the clip includes an extension portion and an attachment portion, wherein the extension portion is inserted into the bracket and held against the pad by the bracket, and wherein the attachment portion is attachable to the holder by a fastener element.

In one embodiment, the fastener element includes at least one of double-sided adhesive tape, a magnet, a screw, a bolt, a suction cup, or a spring-loaded clip.

In one embodiment, the bracket has bracket arms that are shaped to be removably engaged into the bracket receptacle, and wherein the bracket arms form a gap that is sized to receive the extension portion of the clip.

In one embodiment, the pad and clip are configurable in a standalone configuration.

In one embodiment, the clip is usable to provide a sticker having an information-storage element.

In one embodiment, the apparatus further comprises a sticker attachable to the pad and having the information-storage element, the sticker further including at least one of a branding element, a graphical design, or an activation code.

According to another aspect, an apparatus comprises:

a pad assembly operable to provide information in response to a wireless signal from a mobile device, the pad assembly including a pad having a face surface that is inclined to improve communication with the wireless signal incident thereon.

In one embodiment, the pad assembly includes a paper document holder integrally formed with an extension portion that has the face surface pad.

In one embodiment, the pad assembly further includes:

a clip coupled to the pad to enable the pad to be attached to a holder having physical paper-based documents that contain at least some of same said information in printed form; and

an information-storage element located proximate to the pad and containing said information provided in response to the wireless signal from the mobile device.

In one embodiment, the information-storage element includes at least one or more of a near-field communication (NFC) tag, a radio frequency identifier (RFID) tag, a bar code, a QR code, or a Bluetooth device, and wherein the information-storage element is affixed on the face surface of the pad as a sticker, printed on the face surface of the pad, or integrated within a material of the pad.

In one embodiment, the pad includes a plurality of bracket receptacles shaped to receive at least one of a plurality of clips, and wherein the clips have different shapes such that a particular clip may be received into a particular bracket receptacle so as to provide a different deployment configuration for the pad assembly, wherein different deployment configurations are selectable according to the particular clip and bracket receptacle that is chosen so as to provide different angles of incline for the face surface of the pad.

In one embodiment, the information provided by the pad assembly includes business card information or brochure information.

According to still another aspect, a method comprises:

placing an information-storage element proximate to a face surface of a pad;

deploying the pad in a configuration in which the face surface is inclined so as to improve wireless communication between the information-storage element and a mobile device that sends a wireless signal that is incident on the face surface; and

in response to the wireless signal incident on the face surface, providing information stored in the information-storage element to the mobile device.

In one embodiment, said deploying includes attaching the pad to a holder that holds paper-based documents having same said information in printed form.

In one embodiment, said deploying includes inserting one of a plurality of different clips into one of a plurality of bracket receptacles of the pad, and wherein an angle of incline of the face surface and a deployment configuration of the pad can be varied according to a particular clip and a particular bracket receptacle that is selected.

### BRIEF DESCRIPTION OF THE DRAWINGS

Non-limiting and non-exhaustive embodiments are described with reference to the following figures, wherein like reference numerals refer to like parts throughout the various views unless otherwise specified.

In FIG. 1, shown therein is a system of the present disclosure for providing consumers with an electronic listing of employees to connect with a social network or to save the employees contact information locally or remotely.

In FIG. 2, shown therein is an embodiment of a mounting apparatus that may be used to hold business cards and which may provide electronic listings of business card information using NFC chips, QR codes, Bluetooth and the like.

In FIG. 3, shown therein is an embodiment of a mounting apparatus that is a variation of the embodiment of FIG. 2, which may be used to hold business cards and which may provide electronic listings of business card information using NFC chips, QR codes, Bluetooth and the like.

In FIG. 4, shown therein is an embodiment of a mounting apparatus that is a variation of the embodiments of FIG. 2 and FIG. 3, which may be used to hold business cards and which may provide electronic listings of business card information using NFC chips, QR codes, Bluetooth and the like.

In FIG. 5, shown therein is an embodiment of a mounting apparatus that is a variation of the embodiments of FIG. 2, FIG. 3 and FIG. 4, which may be used to hold business cards and which may provide electronic listings of business card information using NFC chips, QR codes, Bluetooth and the like.

In FIG. 6, shown therein is a side view of an embodiment a mounting apparatus that may be attached to a multi-tier business card holder and that may provide electronic listings of business card information using NFC chips, QR codes, Bluetooth and the like.

In FIG. 7, shown therein is a front view of the mounting apparatus of FIG. 6, which is an embodiment that may be used to attach to a multi-tier business card holder and may provide electronic listings of business card information using NFC chips, QR codes, Bluetooth and the like.

In FIG. 8, shown therein is a top view of the mounting apparatus of FIG. 6, which is an embodiment that may be used to attach to a multi-tier business card holder and may provide electronic listings of business card information using NFC chips, QR codes, Bluetooth and the like.

FIG. 9 is a perspective view of a pad for a mounting apparatus according to one embodiment.

FIG. 10 is a perspective view of a pad for a mounting apparatus according to another embodiment.

FIG. 11 is a perspective view of a pad for a mounting apparatus according to still another embodiment.

FIG. 12 shows an embodiment of a bracket that can be used for the pads of FIGS. 9-11.

FIG. 13 shows the placement of the bracket of FIG. 12 into a bracket receptacle of the pads of FIGS. 9-11 in according to one embodiment.

FIGS. 14-17 show embodiments of various clips for a mounting apparatus.

FIGS. 18-29 show the deployment of various embodiments of the mounting apparatus.

FIG. 30 shows examples of stickers that can be used for a mounting apparatus according to various embodiments.

FIG. 31 is a block diagram of an embodiment of a system.

### DETAILED DESCRIPTION

Embodiments of a mounting apparatus for short-range wireless communication and techniques to process/use data that are communicated via the mounting apparatus are described herein. In the following description, numerous specific details are given to provide a thorough understanding of embodiments. One skilled in the relevant art will recognize, however, that the invention can be practiced without one or more of the specific details, or with other methods, components, materials, etc. In other instances, well-known structures, materials, or operations are not shown or described in detail to avoid obscuring aspects.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Referring now to the present disclosure in more detail, in FIG. 1 there is shown an embodiment of a process/method and system for providing consumers with an electronic listing of employees; wherein, the consumer may connect with the employee on a social network or may save the employees contact information locally or remotely. The process and system may involve a mounting apparatus, in the form of a device 100 shown in FIG. 1. The device 100, which may have NFC capabilities or bar code scanning/providing capabilities, may be attached to business card holders, near checkout counters, on business desks, and the like. For example and as will be described in further detail below, the device 100 and other embodiments of the mounting apparatus may be attached to a business card holder, a brochure holder, or other type of structure that holds conventional paper-based documents or other information on physical literature in printed form, which is the same or similar as some of the information obtained in electronic form from the device 100 by the user's mobile device. The device 100 may have affixed thereto (such as in the form of a sticker) or integrated therein an NFC tag (such as in the form of an integrated circuit chip having transceiver circuitry), a radio frequency identifier (RFID) tag, a machine-readable symbol (such as a bar code, QR code, and the like), or other information-storage element capable to provide information to an interrogating user device (such as a wireless phone or other mobile device).

A consumer may use a mobile device to tap or scan 150 the device 100, which may initiate a web browser or mobile application session 200 on the mobile device. In one embodiment, physical contact between the user's mobile device and the device 100 is not required at 150. Rather, the user may hover the mobile device in close proximity to the device 100 in order to enable wireless communication between the mobile device and the information-storage element of the device 100.

Further, one embodiment may determine whether the consumer is logged in 300 and may allow the consumer to login or register 400 or continue without registration 450. Further, there may be an option to allow the consumer to download or open a native mobile application 500 on their device. If the mobile application is downloaded or opened 600, a list of a plurality of employees 800 may be provided within the mobile application. Further, if the website is opened within the mobile web browser 700, a list of a plurality of employees 800 may be provided within the mobile web browser. Further, the consumer may select 900 one or more employees from a list of a plurality of employees 800, which may create a link between the consumer and the employees chosen within a remote database 950 and may be used within a social network. The consumer may store the information about the employee, such as contact information obtained by interrogating the device 100, in the consumer's (user's) mobile device and/or at some other location, for future use to obtain products/services, social networking, or other communication purposes. Further, in more detail, a plurality of relevant details; including handset device, device ID, time of day, location, and the like, may be stored within the remote database 950.

In more detail, still referring to the embodiment of FIG. 1, the device 100 may have a method of communication, including NFC technology, bar codes, QR codes, and the like, and may be embedded or printed on the device 100 or may be attached or located near the device 100 in a plurality of ways, including stickers, cardboard stands, poster boards, magnets, and the like. Further, the device 100 may be a plurality of physical devices, including; business card holders, which may be capable of holding a plurality of business cards for a plurality of employees or professionals; posters boards, which may be located near point of sale counters or retail window locations in front of the store; brochure holders for holding informational brochures about a company and/or its products and services; and the like.

In more detail, still referring to the embodiment of FIG. 1, a list of a plurality of employees 800 may only contain one employee in some instances, or may contain a plurality of employees in other instances. Further, one embodiment may provide settings or capabilities to automatically create a link between the consumer and the employees chosen within a remote database 950 without user intervention. Further, one embodiment may provide the ability for the consumer to store contact information locally on their handset device. Further, the list of employees 800 may be a list of professionals, list of business information, department information, and the like.

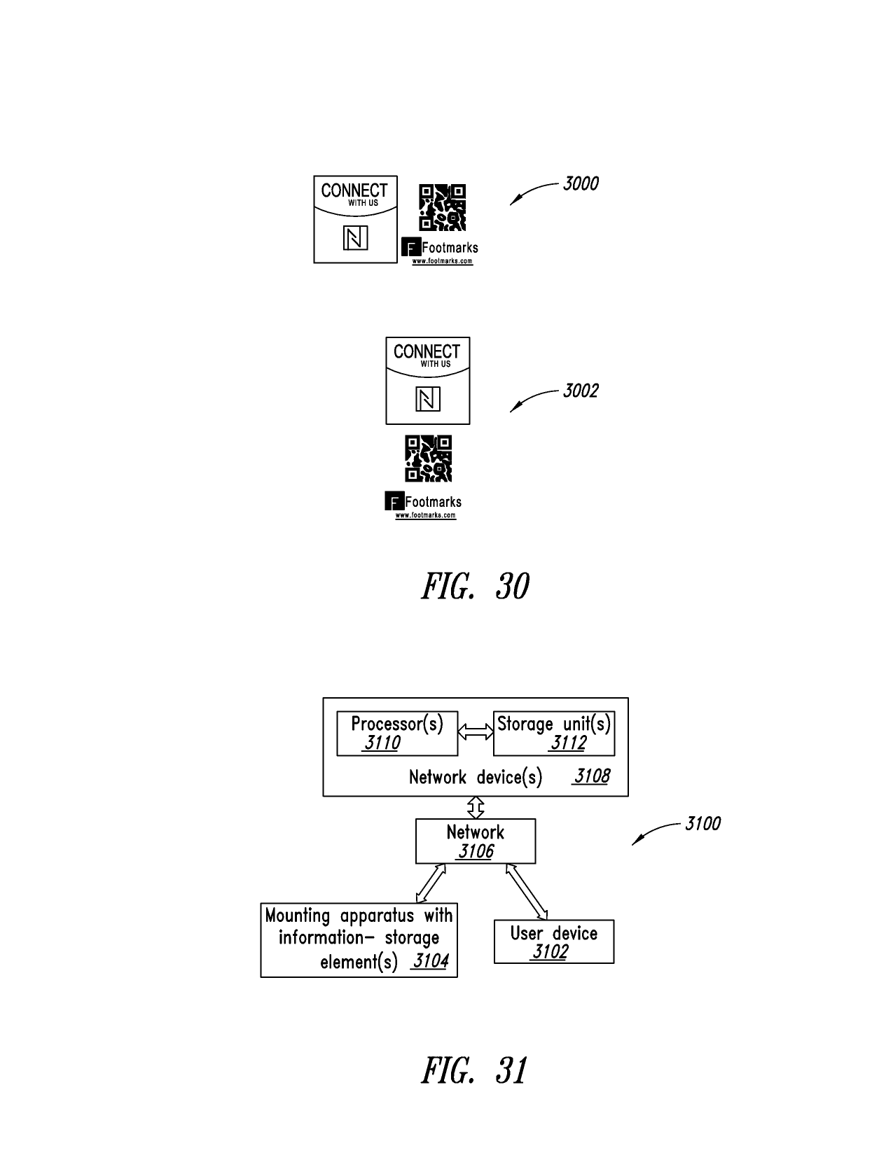

Referring now to FIG. 31, an embodiment of a system 3100 is shown, which can operate in conjunction with the system/method of FIG. 1. The system 3100 may include a user device 3102, such as a wireless phone, Blackberry, iPod, iPad, or other type of consumer electronic device that has the capability to interrogate or otherwise wirelessly communicate with a NFC tag, RFID tag, bar code or QR code or other machine-readable symbol, Bluetooth device, other information-storage element, etc. The device 100 of FIG. 1 (having the information-storage element) and the mounting apparatus are collectively represented in the system 3100 by a pad assembly 3104. The assembly 3104 and/or the user device 3102 communicate wirelessly with each other (depicted by the arrow in FIG. 31). The assembly 3104 and/or the user device 3102 may in turn use a network 3106 to communicate with one or more back-end remote network devices 3108.

The network device 3108 can include one or more processors 3110 coupled to one or more storage units 3112. The storage unit 3112 of one embodiment may include a non-transitory computer-readable medium, such as a memory, having computer-readable instructions (such as software) stored thereon that are executable by the processor(s) 3110. For example in some embodiments, certain operations depicted in FIG. 1 may be performed by software executed by the processor(s) 3110. The storage unit 3112 may also store employee lists, social networking software and data, and other software or information that can be communicated to the user device 3102 via the assembly 3104 and/or directly to the user device 3102 without using the assembly 3104.

The network device(s) 3108 can comprise part of a social networking site in one embodiment, such that the information and other relationships may be created and stored therein, including information obtained by the user by interrogating the device 100. The network device(s) 3108 may also be backend databases that store employee information, product/service information, or other information that can be supplied or otherwise linked to the device 100, for later retrieval by the user/consumer.

Referring now to FIG. 2, an embodiment comprises a plurality of components including a business card holder 2100, a display card 2000, and an information-storage element in the form of a communication device 2050, which may be used to hold business cards and which may provide electronic listings of business card information. Without limitation, the communication device 2050 of one embodiment may be capable of sending RF signals or be scanned or otherwise interrogated by an interrogation device, such as a user's mobile device. Further in one embodiment, the communication device 2050 may be a near field communications chip. Further in one embodiment, the communication device 2050 may be a QR code or other machine-readable symbol adhered to or printed on the display card 2000.

Further in one embodiment, the communication device 2050 may be attached to the display card 2000, using adhesive, using suction cup devices, using magnets, printed with ink, mechanical fasteners (such as screws or nuts/bolts or clips), and the like. Further, the communication device 2050 may contain data that may be transmitted to a reading/interrogation device, such as, a mobile handset, smart phone, and the like. Further, without limitation, the data contained by the communication device 2050 may be a URL, contact information, and the like.

In more detail, still referring to the embodiment shown in FIG. 2, the construction details are that the business card holder 2100 and display card 2000 may be made of plastic or any other sufficiently rigid material such as card board, stock paper, metal and the like. Further, the display card 2000 may be adhered to the business card holder 2100 using a magnetic system, using suction cup devices, adhesive material, mechanical fasteners, and the like. Further, the business card holder 2100 may be any device capable of holding business cards and may be capable of holding only one business card or a plurality of business cards. Further, the business card holder 2100 may have one slot available to hold business cards or may have a plurality of slots available to hold business cards. Further, the business card holder 2100 may be in a plurality of shapes and sizes and made of various materials. While the various embodiments shown and described herein are generally in the context of being used for a business card holder, it is understood that such implementation is merely an example. Other embodiments may be used for other types of holders for paper-based documents, such as brochure holders and the like.

Referring now to FIG. 3, an embodiment comprises a plurality of components including a business card holder 2100 and a communication device 2050, which may be used to hold business cards and which may provide electronic listings of business card information. Without limitation, the communication device 2050 of one embodiment may be capable of sending RF signals or be scanned or otherwise interrogated by an interrogation device, such as a user's mobile device. Further in one embodiment, the communication device 2050 may be a near field communications chip. Further in one embodiment, the communication device 2050 may be a QR code or other machine-readable symbol adhered to or printed on the business card holder 2100. Further in one embodiment, the communication device 2050 may be embedded into the material of the business card holder 2100. Further in one embodiment, the communication device 2050 may be any device capable of communicating data to a mobile device capable of receiving data.

Referring now to FIG. 4, an embodiment comprises a plurality of components including a business card holder 2100, an extension 3000 of the business card holder 2100, and one or a plurality of communication devices 2050, which may be used to hold business cards and which may provide electronic listings of business card information. In more detail, the extension 3000 of one embodiment may be sufficient in size to allow for a plurality of communication devices 2050.

In more detail, still referring to the embodiment shown in FIG. 4, the construction details are that the business card holder 2100 and extension 3000 may be made of plastic or any other sufficiently rigid material such as card board, stock paper, metal and the like. Further, the business card holder 2100 and extension 3000 may come in various shapes and sizes and made of various materials.

Referring now to FIG. 5, an embodiment comprises a plurality of components including a business card holder 2100, an extension 3000 of the business card holder 2100, and a communication device 2050, which may be used to hold business cards and which may provide electronic listings of business card information.

In more detail, still referring to the embodiment shown in FIG. 5, the construction details are that the business card holder 2100 and extension 3000 may be made of plastic or any other sufficiently rigid material such as card board, stock paper, metal and the like. Further, the business card holder 2100 and extension 3000 may come in various shapes and sizes and made of various materials.

Referring now to FIG. 6, an embodiment comprises a plurality of components including a radio frequency device 6200, a power source 6100, a near-field communication chip 6300, bar code device 6400, and an enclosure 6000, which may be used to hold electronic business card data and which may provide electronic listings of business card information to consumers. The construction details are that the enclosure 6000 may be made of plastic or any other sufficiently rigid material such as card board, stock paper, metal and the like. Further, the enclosure 6000 may come in various shapes and sizes and made of various materials. Further, the enclosure 6000 may have adhesive, so that it may attach to other devices.

The embodiment of FIG. 6 may, for example, be a side view (including a cutaway view) of one or more of the embodiments of an extension shown in FIGS. 4-5. In the embodiment shown, the shape (side view) of the extension can be somewhat similar to a trapezoid.

Purely by way of example, certain dimensions of various surfaces are shown in FIG. 6 and it is understood that other values for these dimensions may be provided in other embodiments: 55 mm for the face surface section having the radio frequency device 6200, power source 6100, near-field communication chip 6300, and bar code device 6400; 16 mm for the top surface section; 55 mm for the rear surface section; 58 mm for the bottom surface section; and 12 mm for the front surface section. In one embodiment, both of the side surfaces (planar to the drawing sheet having FIG. 6) may be substantially flat, such that the flat surface may lie flat against the side surface of the business card holder, such as shown in FIGS. 4-5.

In one embodiment, the face surface section (shown as having a length of 55 mm in FIG. 6) may be oriented at an angle to optimize or otherwise improve the wireless communication between the user's mobile device and the device(s) 6200 or 6300 or 6400 located on or in proximity to that face surface. For example, one or more of the devices 6200 or 6300 or 6400 may be directional in nature and/or the transceiver/reader of the user's device may be directional in nature as well, such that optimized or otherwise improved transmission/reception/interrogation is provided if the surface is inclined at a certain angle to provide a better line of sight with the user's device or to provide a more direct energy/RF path to the user's device.

As an example, a barcode reader, NFC reader, RFID reader, etc. on the user's device may be located at approximately the center of the bottom panel of the user's device. The user may also have a natural or comfortable orientation of his/her wrist and hand while using the user device to scan/read/interrogate or otherwise hover over a tag. Hence, the angle of incline of the face surface of the extension 6000 can be provided such that the angle of incline is substantially the same as the angle of the bottom panel of the user's device, as the user hovers the user device over the face surface using a natural/comfortable hand and wrist orientation and motion of the user. As an example, the angle of incline of the face surface can be between 30 and 60 degrees from horizontal, with the embodiment of FIG. 6 showing an approximately 45 degree angle of incline. With this range of the angle of incline, an interrogation beam (wireless signal) of the user device can have a generally or approximately normal/perpendicular angle of incidence with respect to the face surface.

In yet more detail, still referring to the embodiment shown in FIG. 6, the radio frequency device 6200 may be Bluetooth technology or other RFID technology. Further, the power source 6100 may be a 3V coin battery or any other sufficient power supply. Further, some embodiments may not include the radio frequency device 6200 or power source 6100 as they may be optional features in such embodiments. Further, the near-field communication chip 6300 may be printed on a sticker that may be adhered to the enclosure 6000. Further, the near-field communication chip 6300 may be printed directly to the enclosure 6000 or any other sufficient method to associate the near-field communication chip 6300 with the enclosure 6000. Further, the bar code device 6400 may be printed on a sticker that may be adhered to the enclosure 6000. Further, the bar code device 6400 may be printed directly to the enclosure 6000 or any other sufficient method to associate the bar code device 6400 with the enclosure 6000. Further, the bar code device 6400 may be a Quick Response code (QR Code) or any other sufficient design or pattern that may be scanned or electronically analyzed to retrieve data.

In yet more detail, still referring to the embodiment shown in FIG. 6, the present disclosure may only include one of the following components that would be associated with the enclosure 6000: bar code device 6400; near-field communication chip 6300, radio frequency device 6200. The power source 6100 may not be a necessary feature of some embodiments based on the chosen configuration. For instance, if a barcode or a passive RFID tag is implemented, there may be no need for a separate power supply.

Referring now to FIG. 7, a frontal view of the embodiment presented in FIG. 6 is shown. As can be better seen for this embodiment, the extension 6000 has a generally rectangular front profile, with flat sides.

Referring now to FIG. 8, a top view of the embodiment presented in FIG. 6 is shown. As also can be better seen for this embodiment, the extension 6000 has a generally rectangular top profile, with the flat sides.

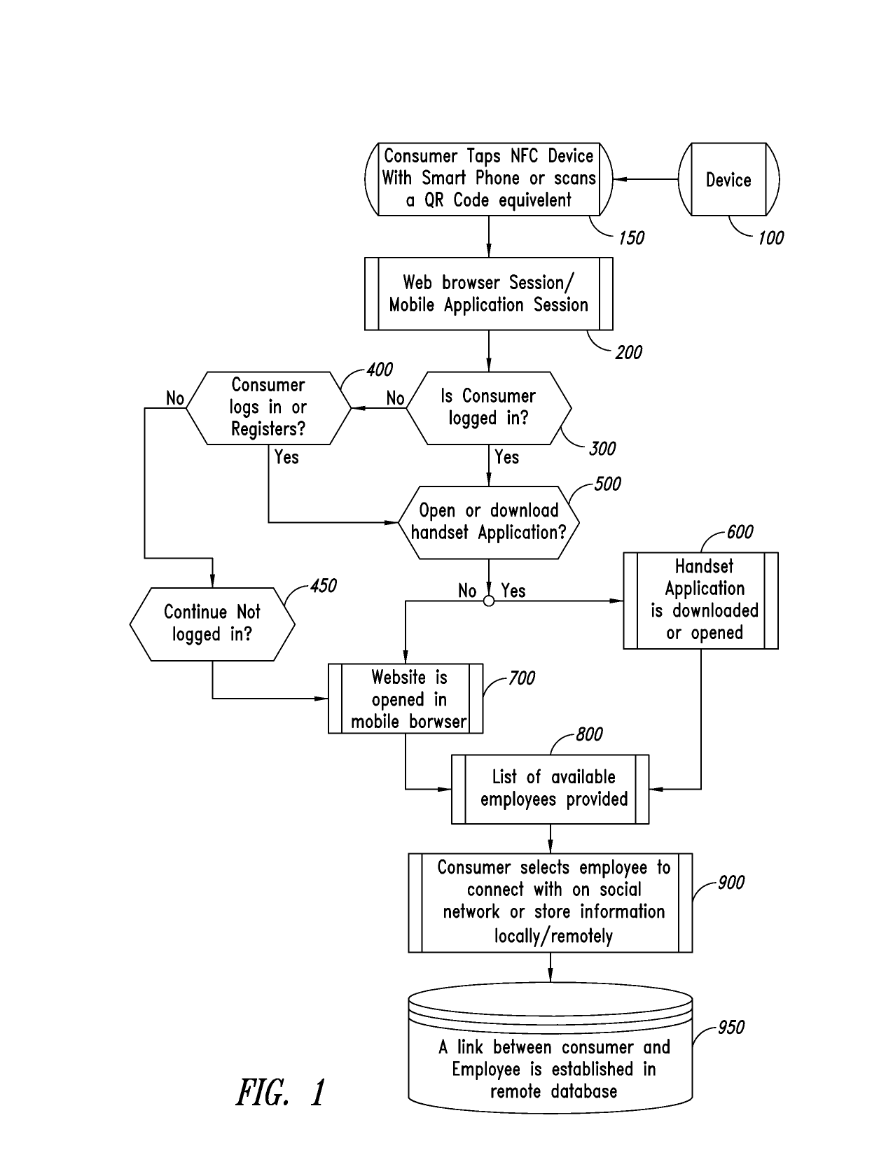

Other embodiments of a mounting apparatus and some example deployment configurations will now be shown and described with respect to FIGS. 9-29. In such embodiments, the mounting apparatus comprises a combination of at least one pad having a face surface, one bracket, one clip, and some type of attachment element, such as double-sided adhesive tape, magnet(s), screw(s)/bolt(s), suction cup(s), spring-loaded clip(s), other fastener element, etc. to adhere the mounting apparatus to a surface. Examples of the surface on which the mounting apparatus may be attached may be various types of business card holders, brochure or pamphlet holders. Other examples include attachment of the mounting apparatus to other surfaces such as restaurant tables, windows, counter tops, office desks, restaurant bill folders, and so on.

As with the embodiments of the mounting apparatus previously described above with respect to FIGS. 2-8, the other embodiments shown and described hereinafter may be used to provide electronic listings of business card information using NFC chips, QR codes, Bluetooth and the like. The NFC chip, QR code, or other type of tag, machine-readable symbol, or information-storage element capable to provide information to an interrogating user device (such as a wireless phone or other mobile device) may be placed on or in close proximity to a face surface of the mounting apparatus, such as via sticker, printing, other attachment method, integrated into the material of the mounting apparatus at or near or within the face surface, or other suitable method so as to enable the user device to successfully obtain the stored information. In one embodiment, the face surface may be inclined, as with the other embodiments previously described above, so as to optimize the communication with the user device. A difference between the additional embodiments that will be described hereinafter, versus the other embodiments previously described above, is that such additional embodiments have a flatter and thinner profile/shape rather than having the rectangular/trapezoidal/cubical shape of the previously described embodiments.

FIGS. 9-11 are perspective views respectively showing three embodiments of a pad of a mounting apparatus. The pads may be provided with various shapes and thicknesses, widths, heights, or other dimensions. For the sake of illustration, the embodiments are depicted as having a generally rectangular face surface. The pad and/or other components of the embodiments of the mounting apparatus maybe made of the same material as the previously described embodiments, including sufficiently rigid plastic material that still has some flexure.

In FIG. 9, a pad 9000 comprises a first portion 9002 and a second portion 9004. The first portion 9002 may have the face surface that includes the information-storage element (e.g., QR code, NFC tag, RFID tag, etc.). The first portion 9002 is arranged relative to the second portion 9004 at an angle, for instance at approximately 120 degrees relative to each other.

The pad 9000 also includes at least one bracket receptacle or a pair of bracket receptacles 9006. In the depicted embodiment, one pair of bracket receptacles is placed along each side of the pad 9000, such that the first portion 9002 has three bracket receptacles, while the second portion 9004 has a single pair of bracket receptacles. Any number of pairs of bracket receptacles may be provided and placed on the portions of the various embodiments of the pads described herein.

As will be shown and described later below, the angular orientation of the first portion 9002, in combination with the location(s) of the bracket receptacles and the type of clip used, will enable the pad 9000 to have a number of possible attachment orientations, while still optimizing the communication between the user device and the information-storage element of the pad 9000. These features are also possible with the other embodiments.

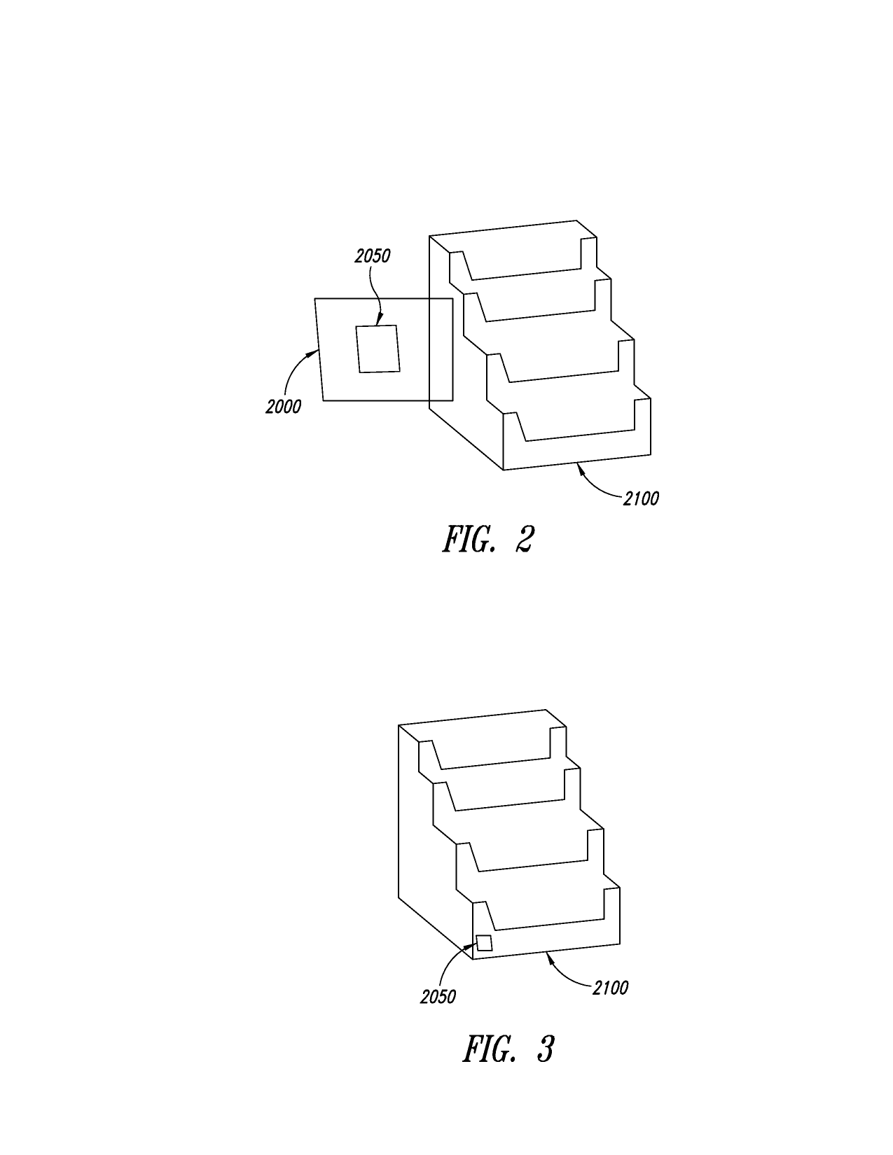

In FIG. 10, a pad 1000 has a generally flat rectangular shape and is comprised of a first portion 1002. Unlike the embodiment of FIG. 9, the pad 1000 does not include a second portion that is arranged at an angle relative to the first portion 1002—only the first portion 1002 is provided and has the information-storage element on, within, or otherwise in close proximity to the face surface of the first portion 1002.

The pad 1000 also includes at least one pair of the bracket receptacles 9006. In the depicted embodiments, one pair of bracket receptacles 9006 is provided at each side of the pad 1000.

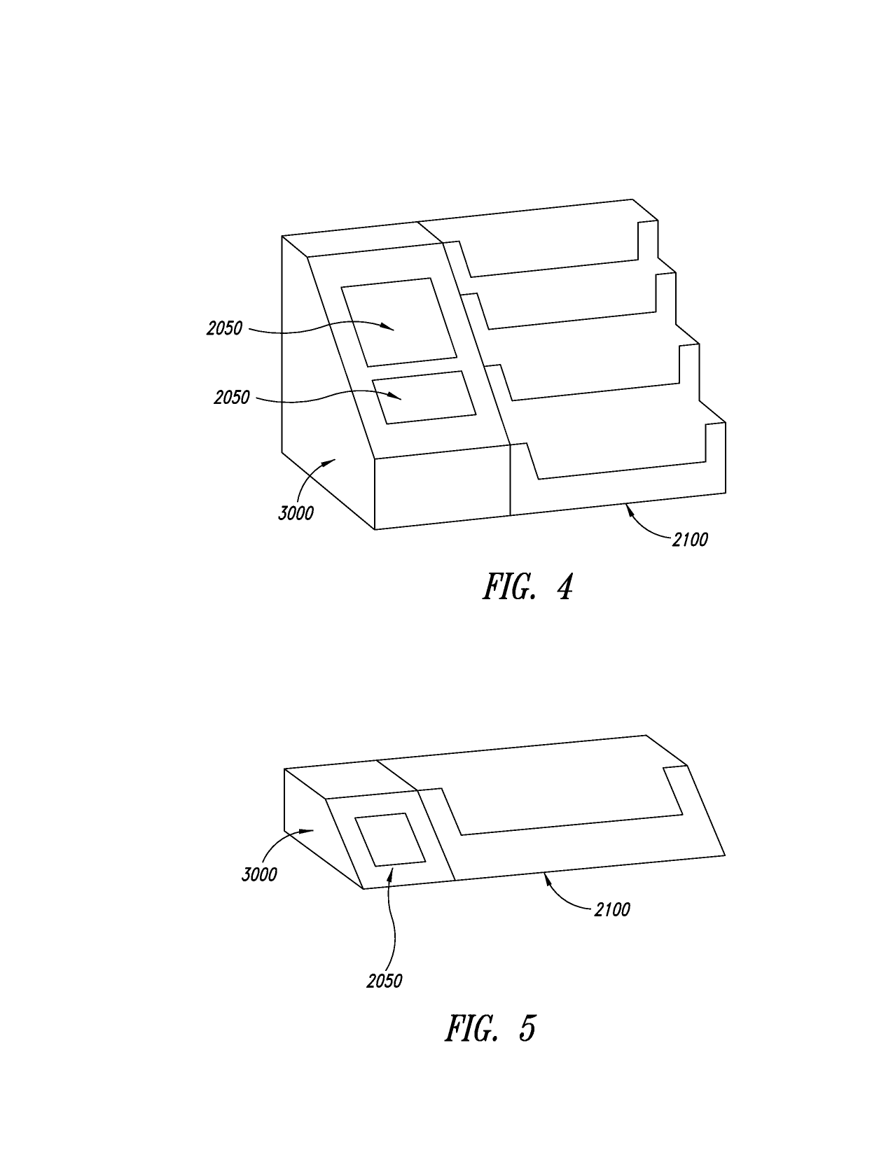

The pad 1100 in FIG. 11 is similar to the embodiment of FIG. 10, except the pad 1100 is slimmer and longer in shape. The pad 1100 has a first portion 1102 having a face surface and at least one pair of bracket receptacles 9006, for example four pairs of bracket receptacles 9006 at each side of the pad 1100.

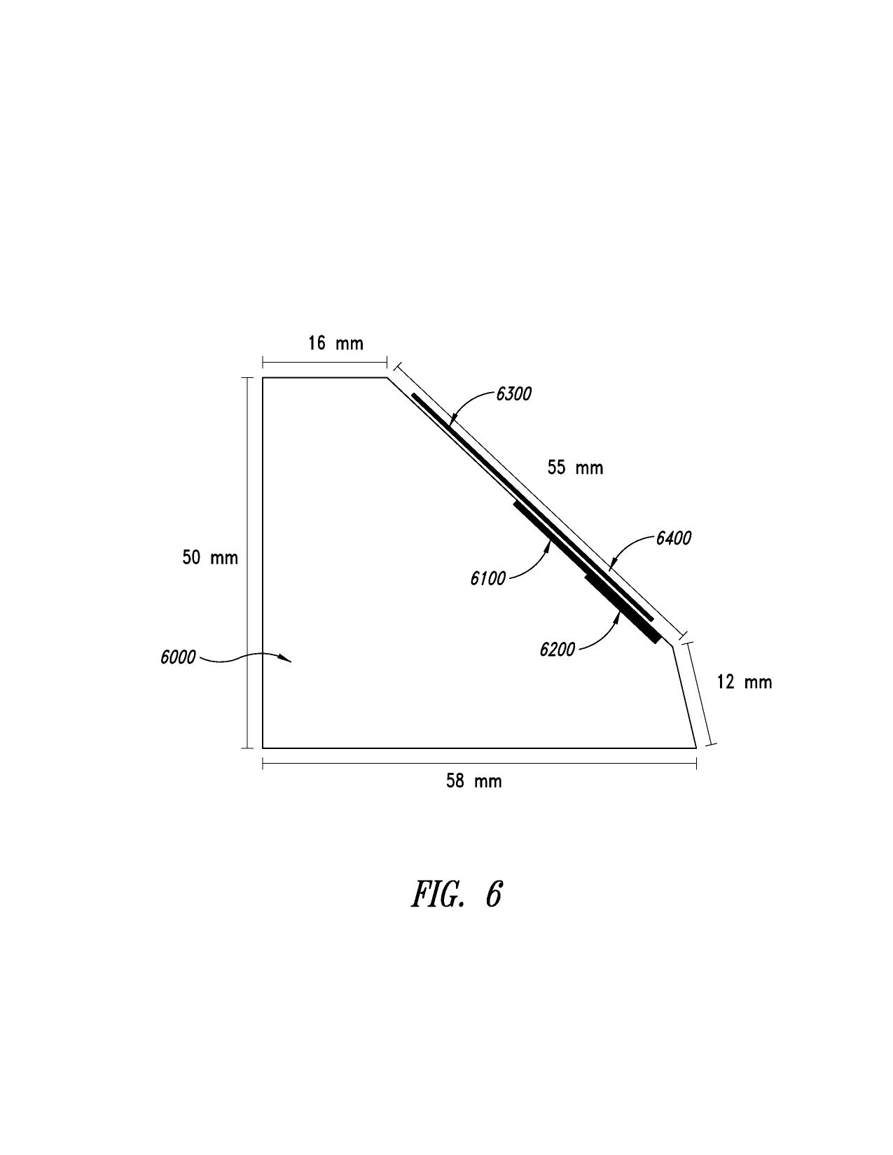

FIG. 12 is a perspective view of one embodiment of a bracket 1200 that can be inserted into the bracket receptacles of the pads. The bracket 1200 includes, at each end, bracket arms 1202 and 1204. Each bracket arm 1202 and 1204 is shaped with an outwardly facing hook, such that the two hooks are faced opposite to each other and are designed to hold the bracket 1200 in place in the bracket receptacle 9006.

The bracket 1200 may be generally C-shaped, such that a gap 1206 is formed between the bracket arms 1202 and 1204 while the bracket 1200 is inserted/engaged into the bracket receptacle 9006. As will be shown and described later below, a portion of a clip or other component can be inserted into the gap 1206 and held in place therein by tension and/or friction between the bracket 1200 and the proximate surface of the pad. Not all brackets need to be placed in the pad in order for the pad to function properly. Just one bracket may be inserted in order to use a clip in some embodiments.

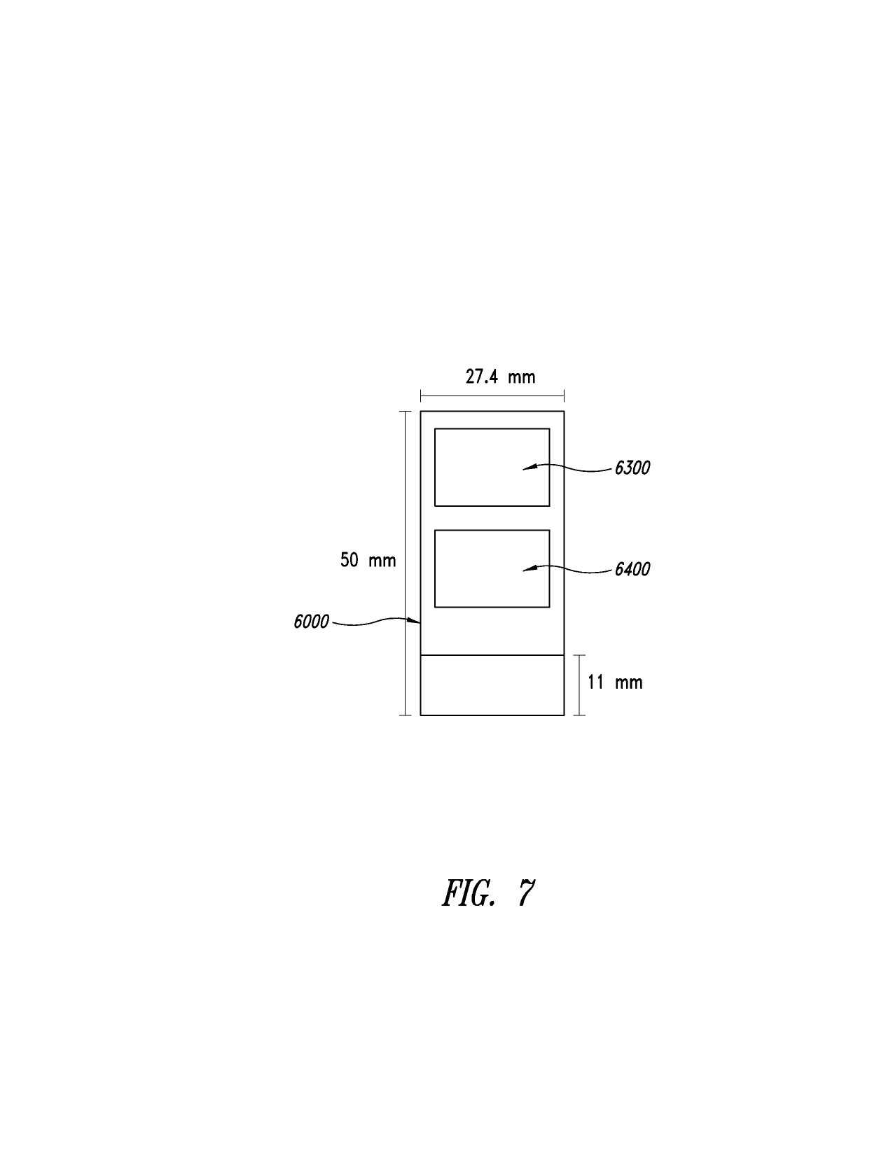

FIG. 13 is a cutaway perspective view showing the placement of the bracket 1200 into the bracket receptacle 9006. As can be seen in this embodiment, the bracket receptacle 9006 forms/includes pair of cavities 1302 and 1304 that are shaped to form a slot to accommodate the respective hooks of the bracket arms 1202 and 1204. With this configuration, the bracket 1200 has flexibility to be bent inwardly to insert the bracket arms 1202 and 1204 into the respective cavities 1302 and 1304, thereby “snapping” the bracket 1200 into place. The bracket 1200 may be removed from the bracket receptacle 9006 by applying pressure to the bracket arms 1202 and 1204 to compress the shape of the bracket 1200, thereby enabling the bracket 1200 to be “snapped” out of the bracket receptacle 9006.

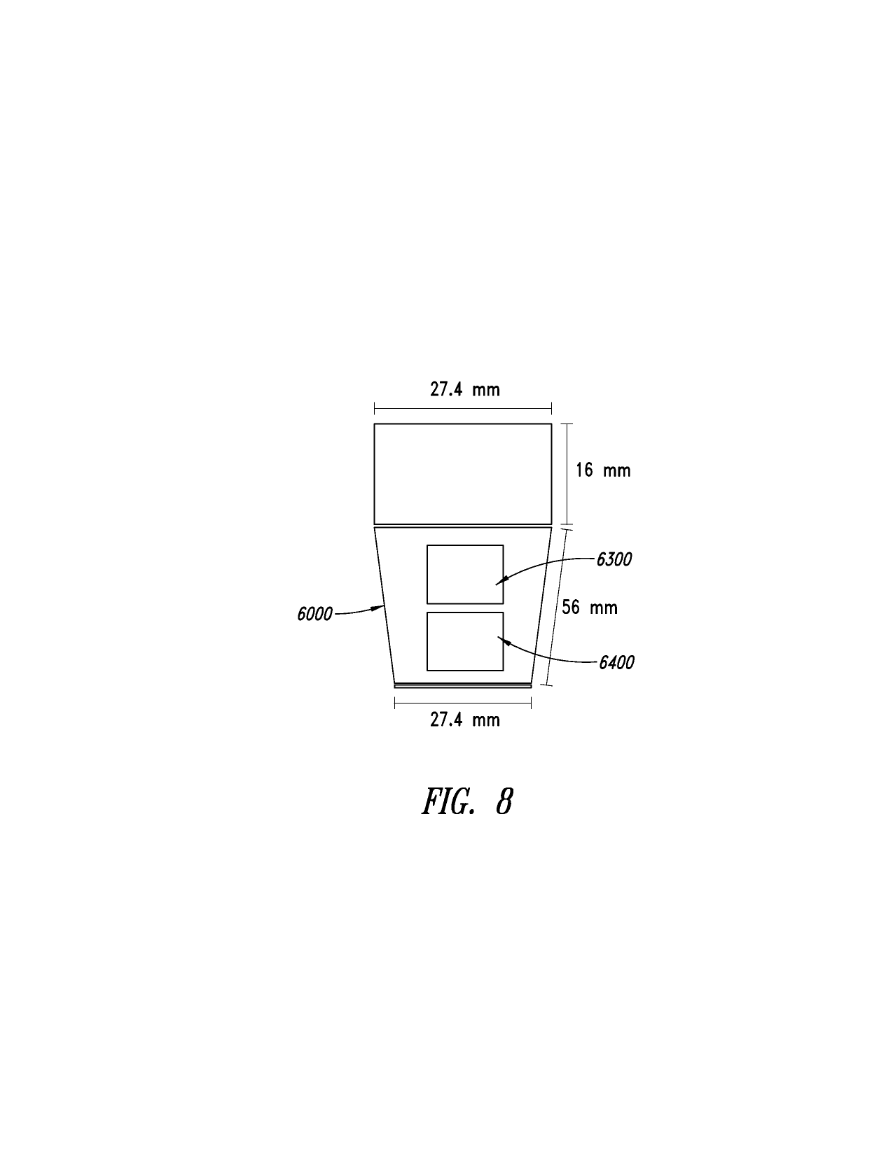

FIGS. 14-17 are perspective views of various clips that may be used with the previously described pads and brackets. The clip(s) may be coupled to any of the pads using the bracket(s) and bracket receptacle(s). The clips can be made of the same material as the brackets and/or pads, or made with some other material that provides sufficient rigidity to support the pad. An example material is plastic.

In FIG. 14, a clip 1400 includes an extension portion 1402 and an attachment portion 1404. The extension portion 1402 is inserted into the gap 1206 provided between the bracket 1200 and the pad surface. The attachment portion 1404 is used for attaching the clip (and hence the pad) to a business card holder, brochure holder, or other object. In one embodiment, if screws, bolts, twist ties, etc. are used for attachment, the attachment portion 1404 may have at least one hole 1406 for the screw, bolt, etc. In other embodiments, such as embodiments that use double-sided adhesive tape, magnets, etc. for attachment, the hole(s) 1406 may be absent.

The embodiment of the clip 1400 may be generally L-shaped, such that the extension portion 1402 and the attachment portion 1404 are oriented 90 degrees relative to each other. In some embodiments of the clip 1400 or other clips disclosed herein, an adjustable joint may be provided between the extension portion 1402 and the attachment portion 1404, thereby enabling the angle between the portions to be adjusted.

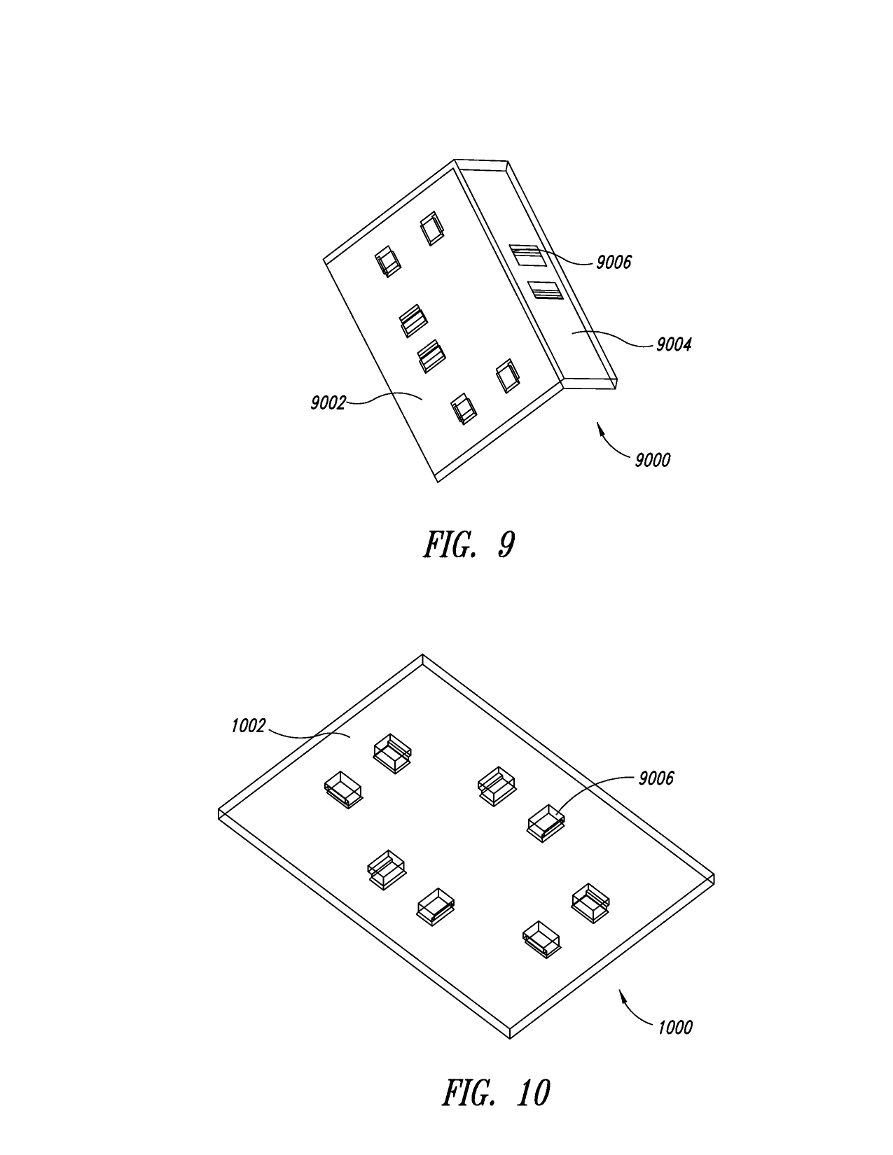

In FIG. 15, a clip 1500 also includes an extension portion 1502 and an attachment portion 1504. Hole(s) 1506 may or may not be present in the attachment portion 1504. In comparison to the embodiment of FIG. 14, the clip 1500 of FIG. 15 has the extension portion 1502 and the attachment portion 1504 oriented at 0/180 degrees of each other, thereby giving the clip 1500 a substantially flat profile along its length.

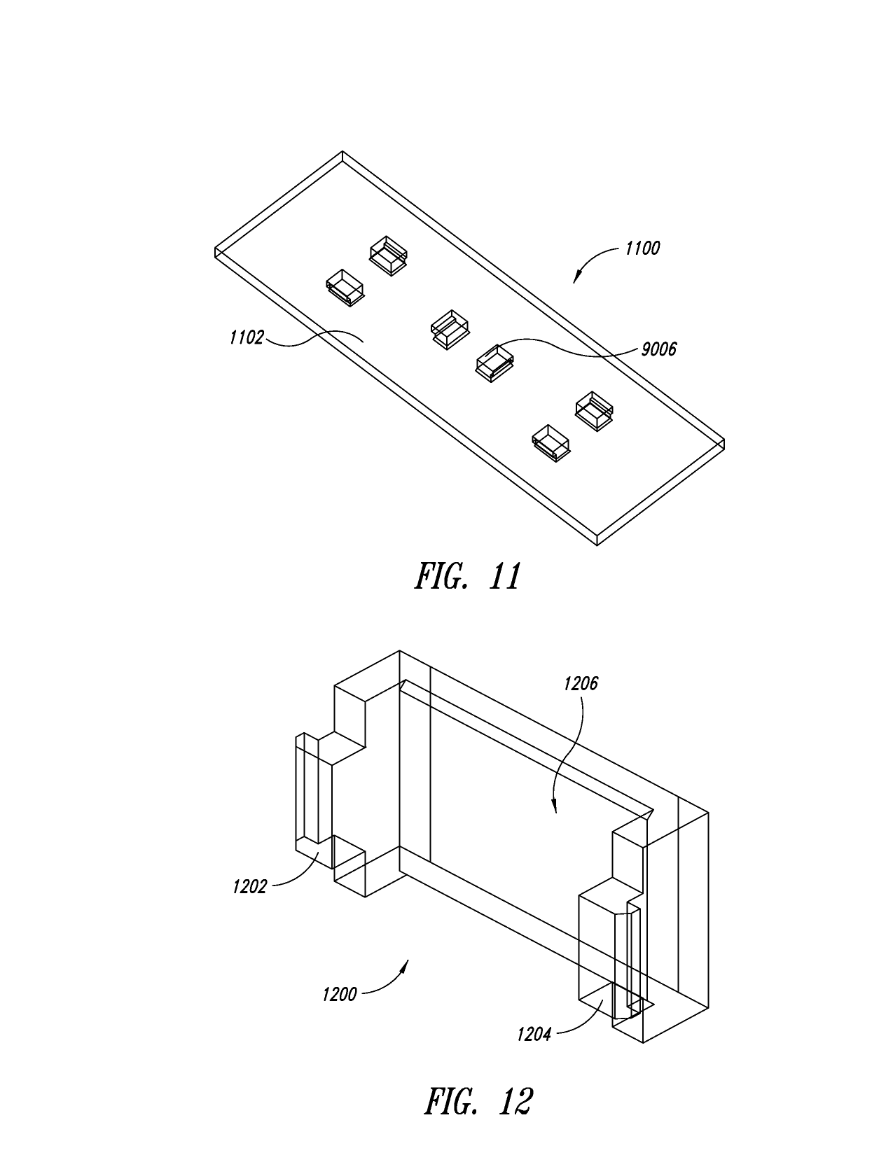

In FIG. 16, a clip 1600 also includes an extension portion 1602 and an attachment portion 1604. Hole(s) 1606 may or may not be present in the attachment portion 1604. In comparison to the clip 1500 of FIG. 15, the clip 1600 of FIG. 16 may have a longer extension portion 1602, and an end region of the extension portion 1602 may displaced at an angle relative to the attachment portion 1604. For instance, the angle may be displaced between 15 and 45 degrees, with the example of FIG. 16 showing the extension portion 1602 being displaced by approximately 30 degrees relative to the attachment portion 1604.

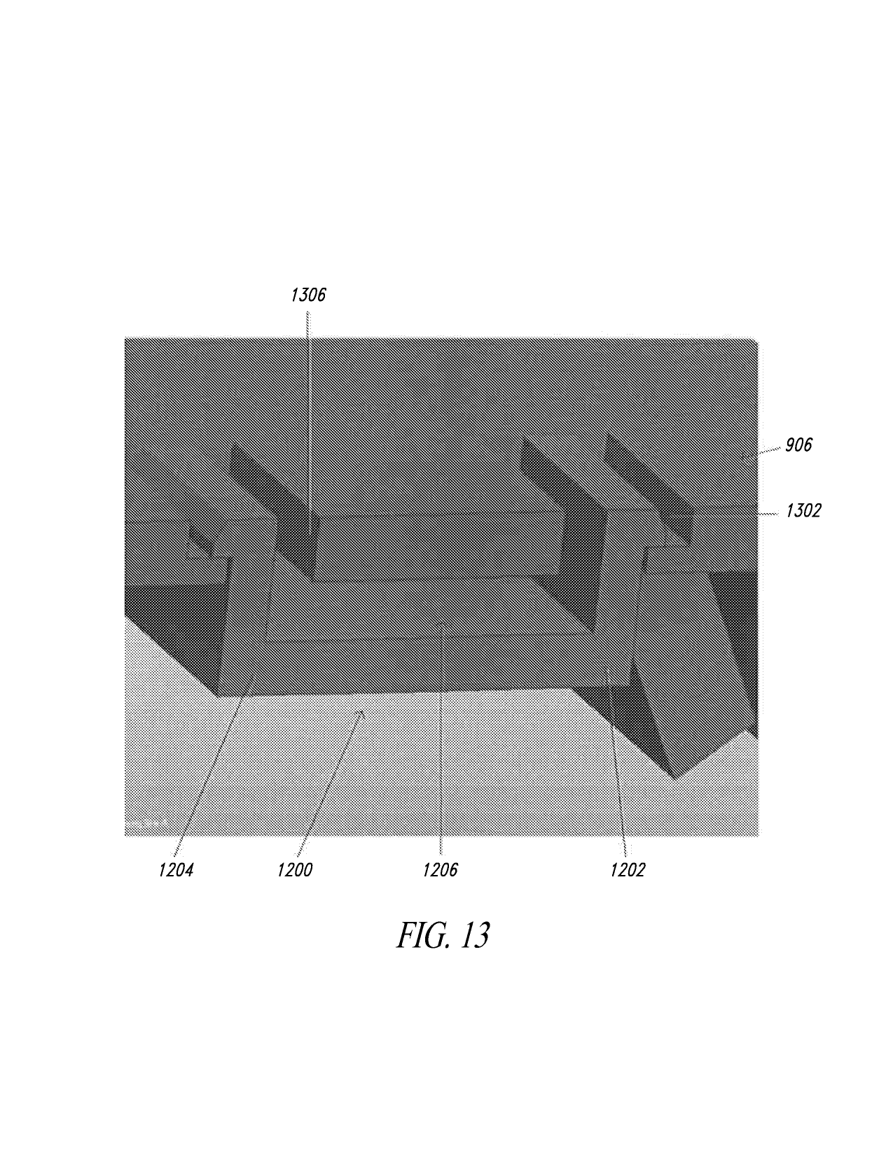

In FIG. 17, a clip 1700 also includes an extension portion 1702 and an attachment portion 1704. The clip 1700 has a somewhat of a C-shaped profile, such that the extension portion 1702 and the attachment portion 1704 form inwardly facing arms of the “C,” with the extension portion 1702 being oriented downward at an angle relative to the attachment portion 1704. This angle may be, for example, between 15 and 60 degrees from horizontal.

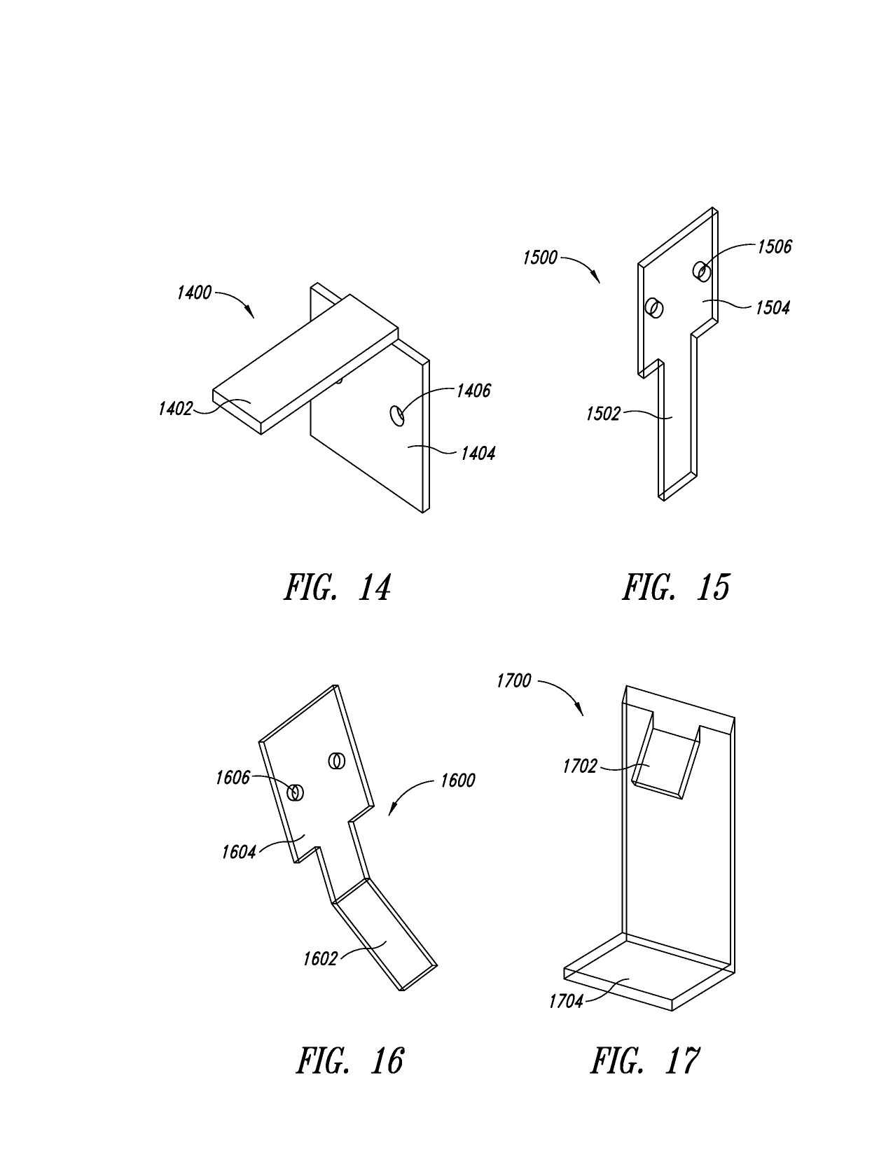

FIG. 18 shows the deployment of the pad 9000 of FIG. 9 using the clip 1400 of FIG. 14. The extension portion 1402 of the clip 1400 is inserted into a pair of bracket receptacles 9006 at the first portion 9002 of the pad 9000. The attachment portion 1404 of the clip 1400 is affixed to a surface of an object 1800, such as a side surface of a business card holder. As can be seen in FIG. 18, the particular orientation of the attachment portion 1404 as it is affixed to the object 1800 and/or the specific location (the particular pair of bracket receptacles 9006 that is selected) on the first portion 9002 where the extension portion 1402 is inserted, contributes to the angle of incline for the face surface of the first portion 9002.

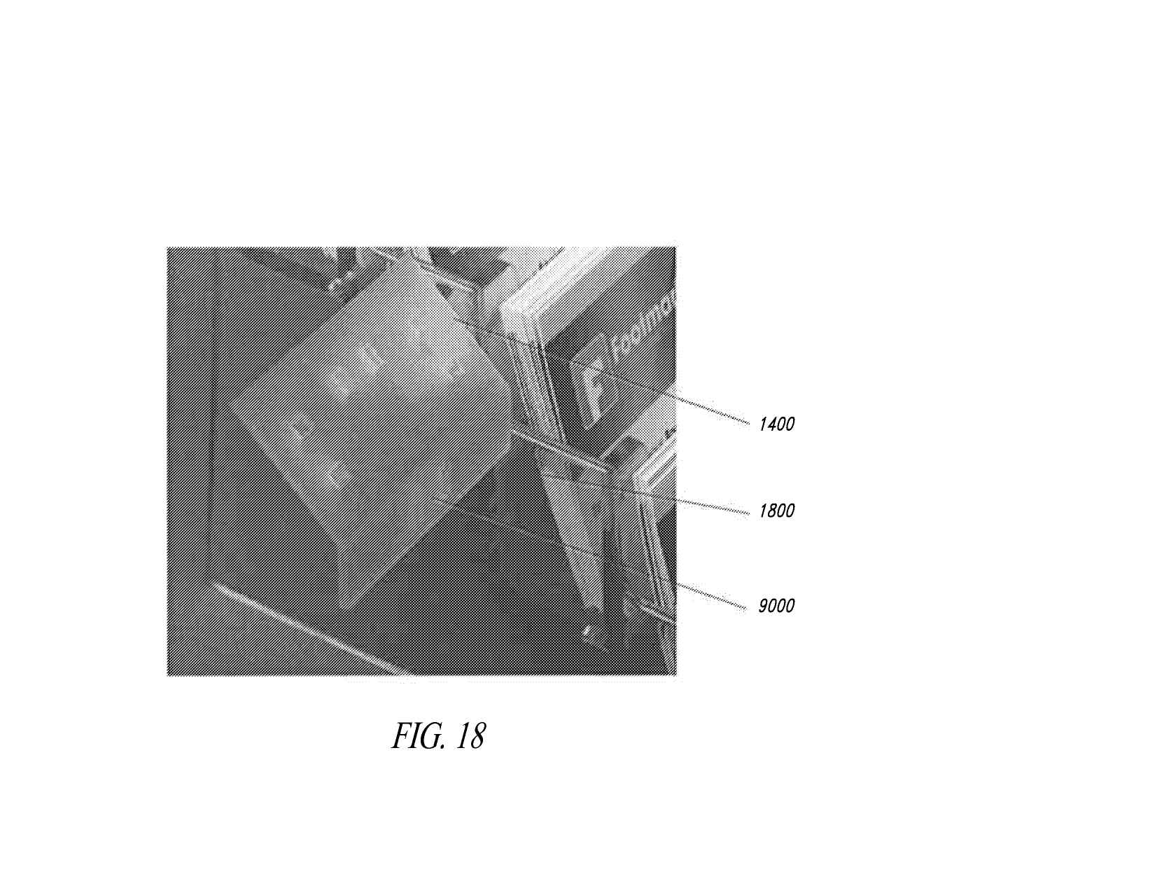

FIG. 19 shows an embodiment wherein the clip 1400 is attached to a pair of bracket receptacles 9006 at the second portion 9004 of the pad 9000. This embodiment provides a standalone configuration wherein the attachment portion 1404 of the clip 1400 provides a flat stable base to support the pad 9000.

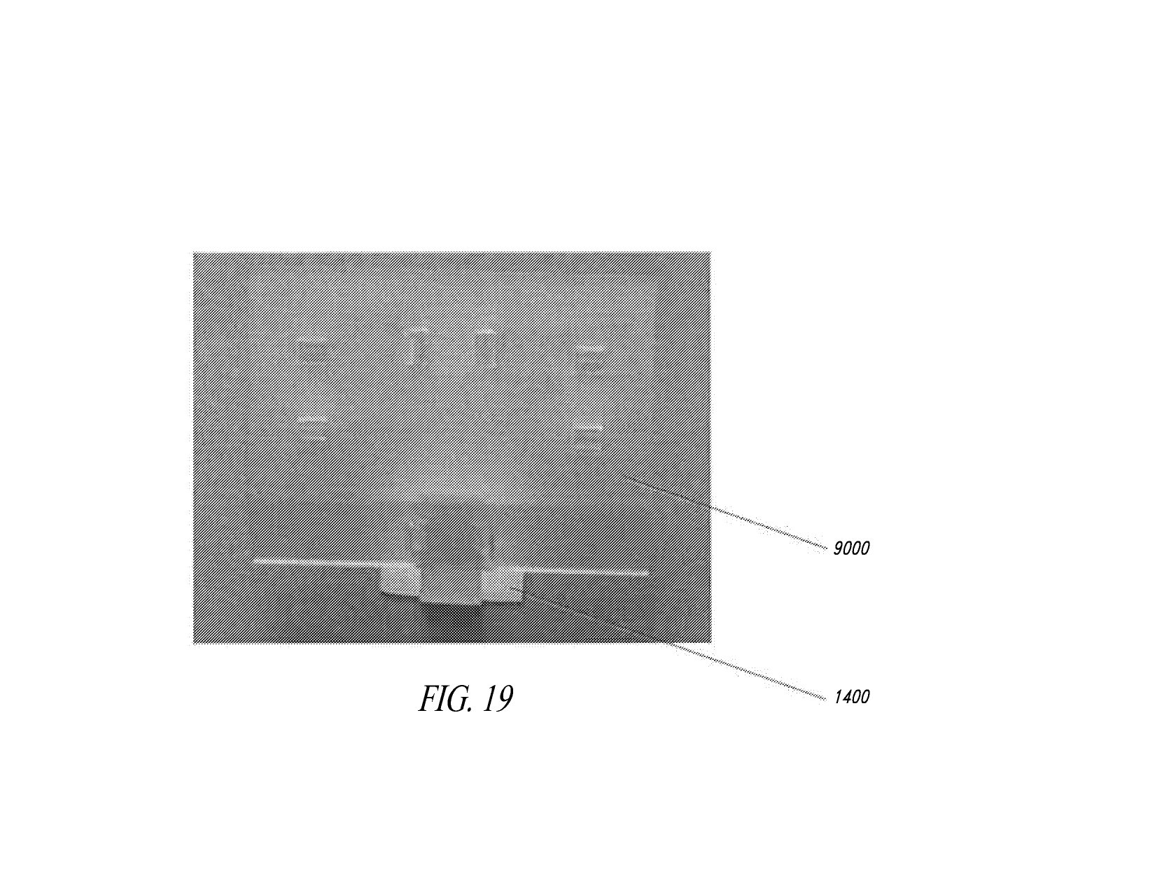

FIG. 20 shows an embodiment wherein the pad 9000 is attached to a surface of an object 2000 (such as a business card holder) using the clip 1500 of FIG. 15. The extension portion 1502 of the clip 1500 is attached to a pair of bracket receptacles 9006 at the second portion 9004 of the pad 9000, while the attachment portion 1504 of the clip 1500 is affixed to the object 2000, thereby enabling the pad 9000 to be held upright by the clip 1500. In this configuration, the angle of incline of the first portion 9002 of the pad 9000 is provided by its true shape/angle, rather than being additionally adjusted by the positioning or shape of the clip 1500.

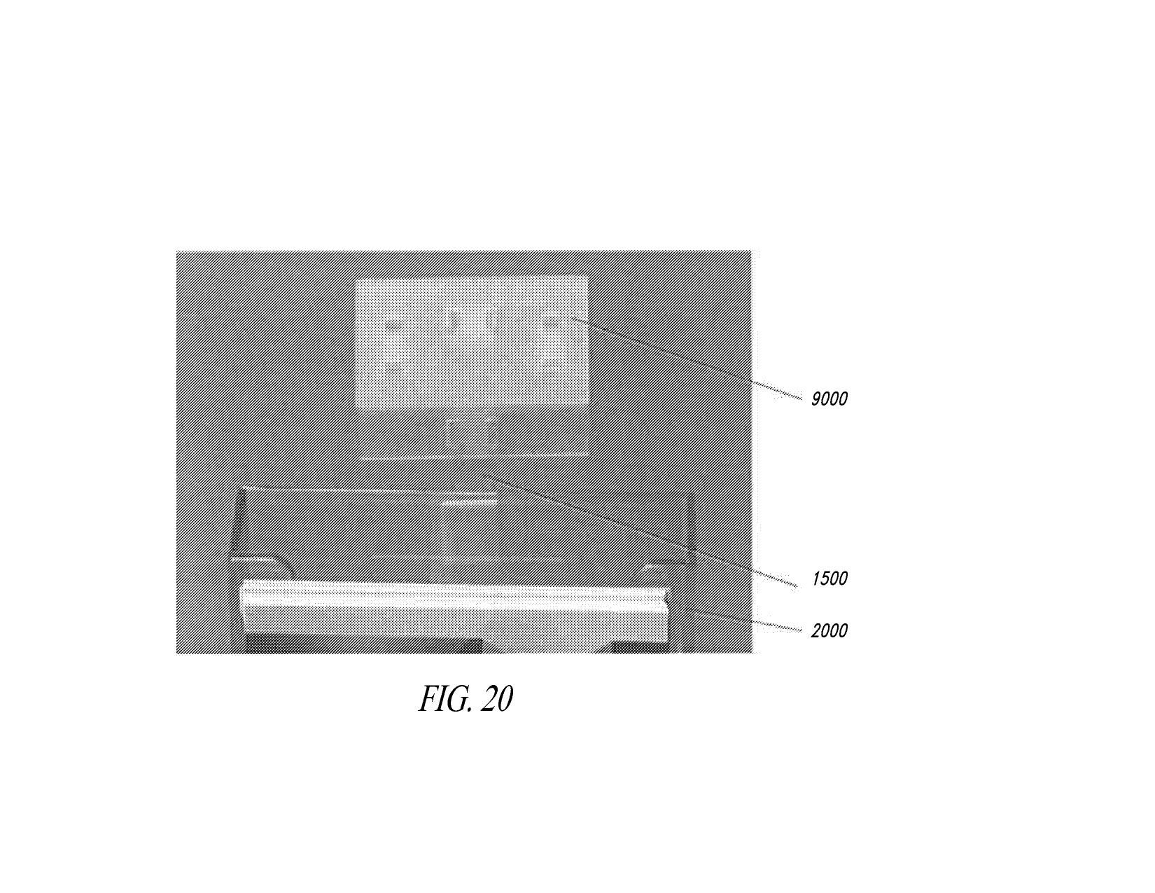

FIG. 21 shows an embodiment wherein the pad 9000 is attached to a surface of an object 2100 (such as a business card holder) using the clip 1700 of FIG. 17. The extension portion 1702 of the clip 1700 is attached to a pair of bracket receptacles 9006 at the first portion 9002 of the pad 9000, while the attachment portion 1704 of the clip 1700 is located underneath the second portion 9004 of the pad 9000. The C shape of the clip 1700 in this deployment configuration enables the pad 9000 to be held in a standup position against the front of the object 2100.

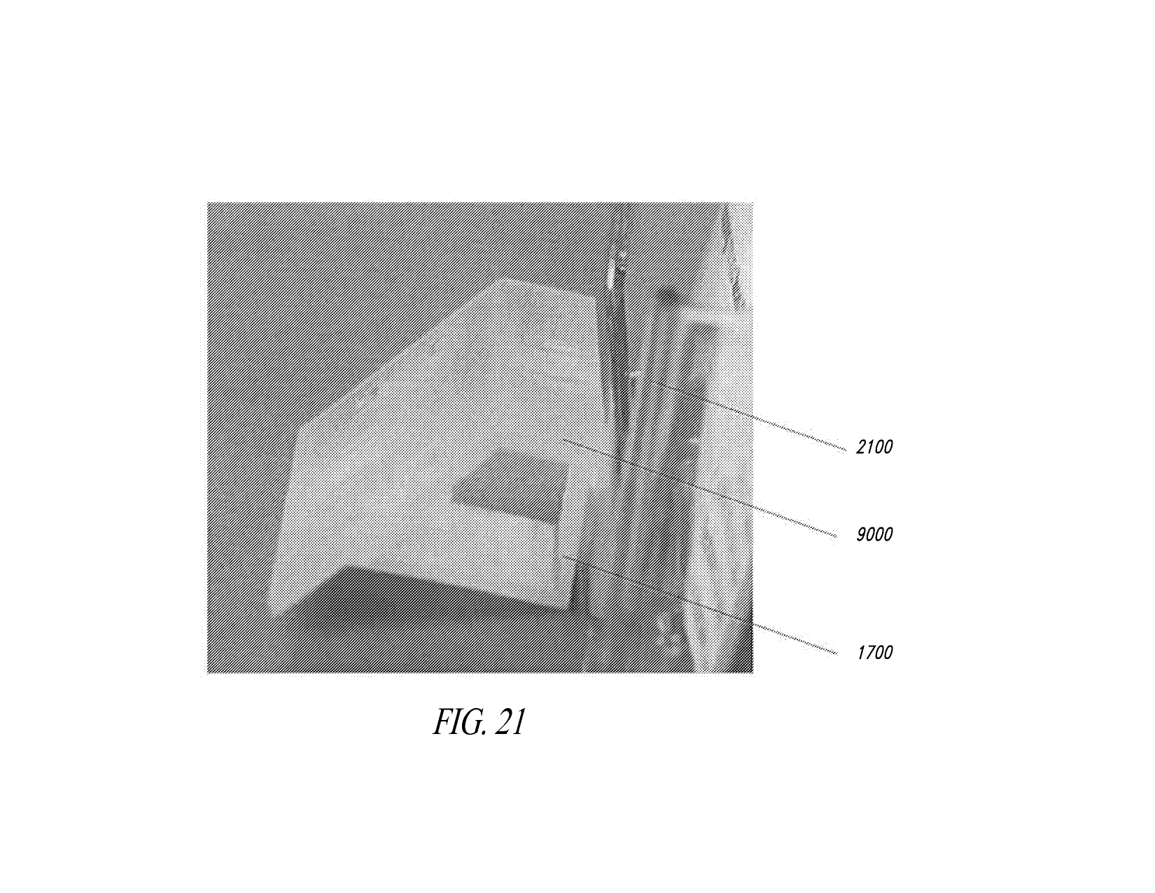

FIG. 22 shows an embodiment wherein the pad 9000 is attached to a surface of an object 2200 (such as a business card holder) using the clip 1700 of FIG. 17. The extension portion 1702 of the clip 1700 is attached to a pair of bracket receptacles 9006 at the first portion 9002 of the pad 9000, while the attachment portion 1704 of the clip 1700 is affixed to the surface of the object 2200. This deployment configuration enables the pad 9000 to be extended away from the side of the object 2200, while still providing an inclined angle for the first surface of the first portion 9002 of the pad 9000.

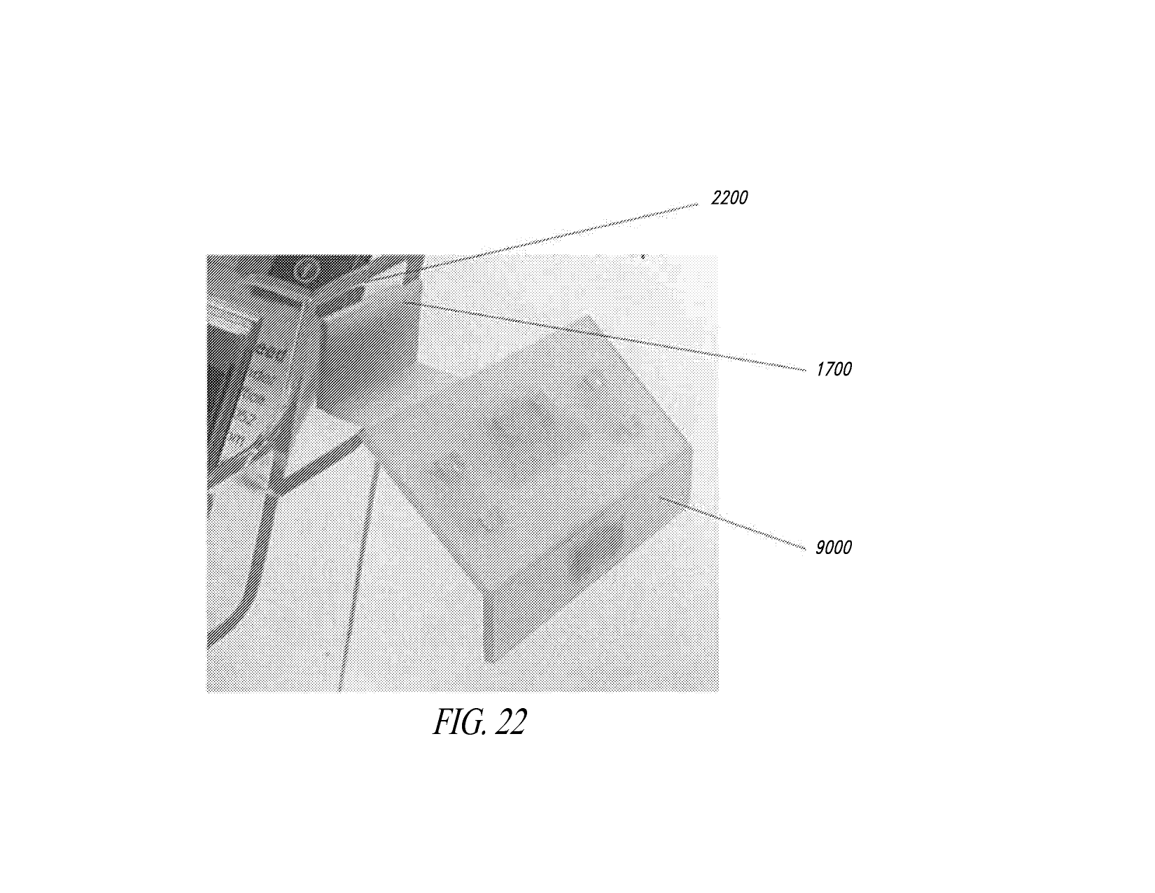

FIG. 23 shows an embodiment wherein the pad 1000 of FIG. 10 is attached to a surface of an object 2300 (such as a business card holder) using the clip 1400 of FIG. 14. The extension portion 1402 of the clip 1400 is attached to a pair of bracket receptacles 9006 of the pad 1000, while the attachment portion 1404 of the clip 1400 is attached to the surface of the object 2300. The attachment of the attachment portion 1404 to the surface of the object 2300 can be angled so as to give an incline to the face surface of the pad 1000.

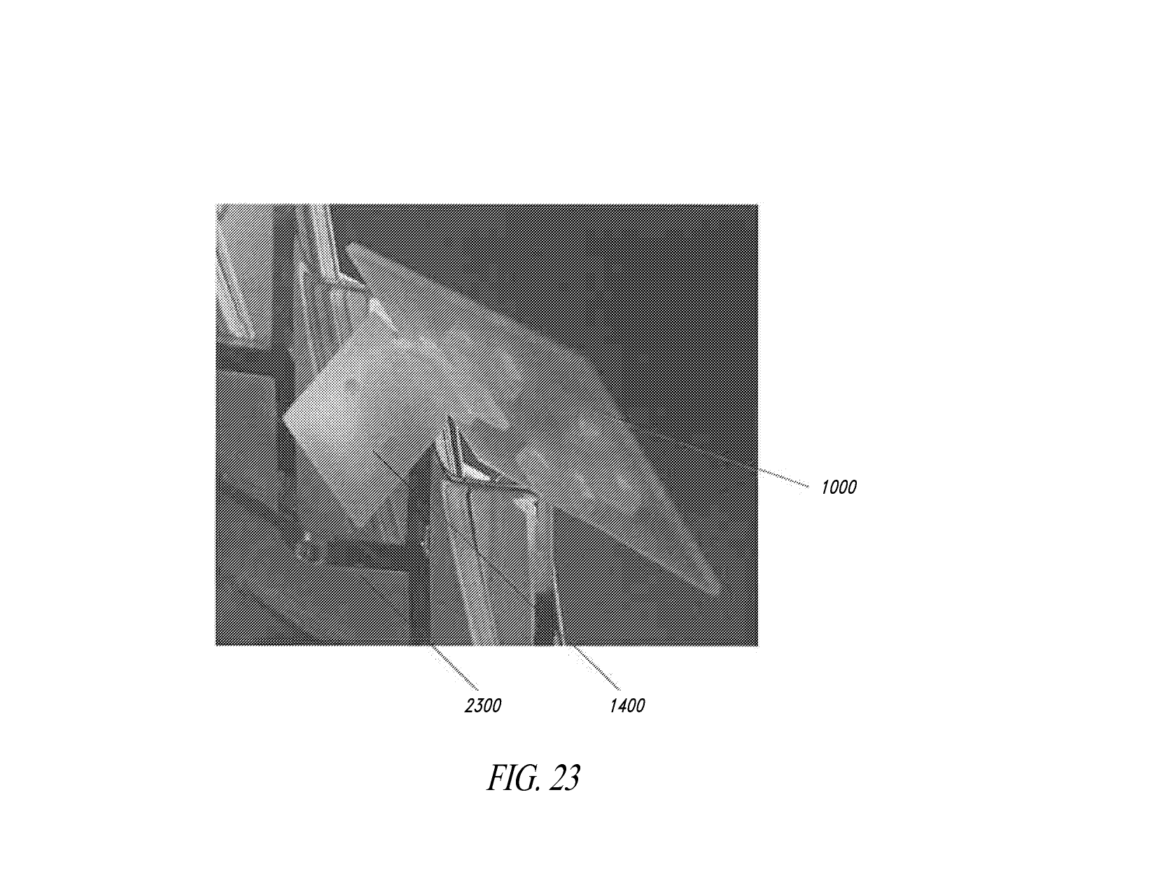

FIG. 24 shows an embodiment wherein the pad 1000 of FIG. 10 is attached to a surface of an object 2400 (such as a business card holder) using the clip 1500 of FIG. 15. The extension portion 1502 of the clip 1500 is attached to a pair of bracket receptacles 9006 of the pad 1000, while the attachment portion 1504 of the clip 1500 is attached to the surface of the object 2400. This deployment configuration enables the face surface of the pad 1000 to be held upright above the business cards that are placed inside the business card holder. Alternatively, the clip 1600 of FIG. 16 may be used, with the angled extension portion 1602 of the clip 1600 being inserted into the bracket receptacles 9006 of the pad 1000, so as to give the face surface of the pad 1000 more of an angled/inclined orientation.

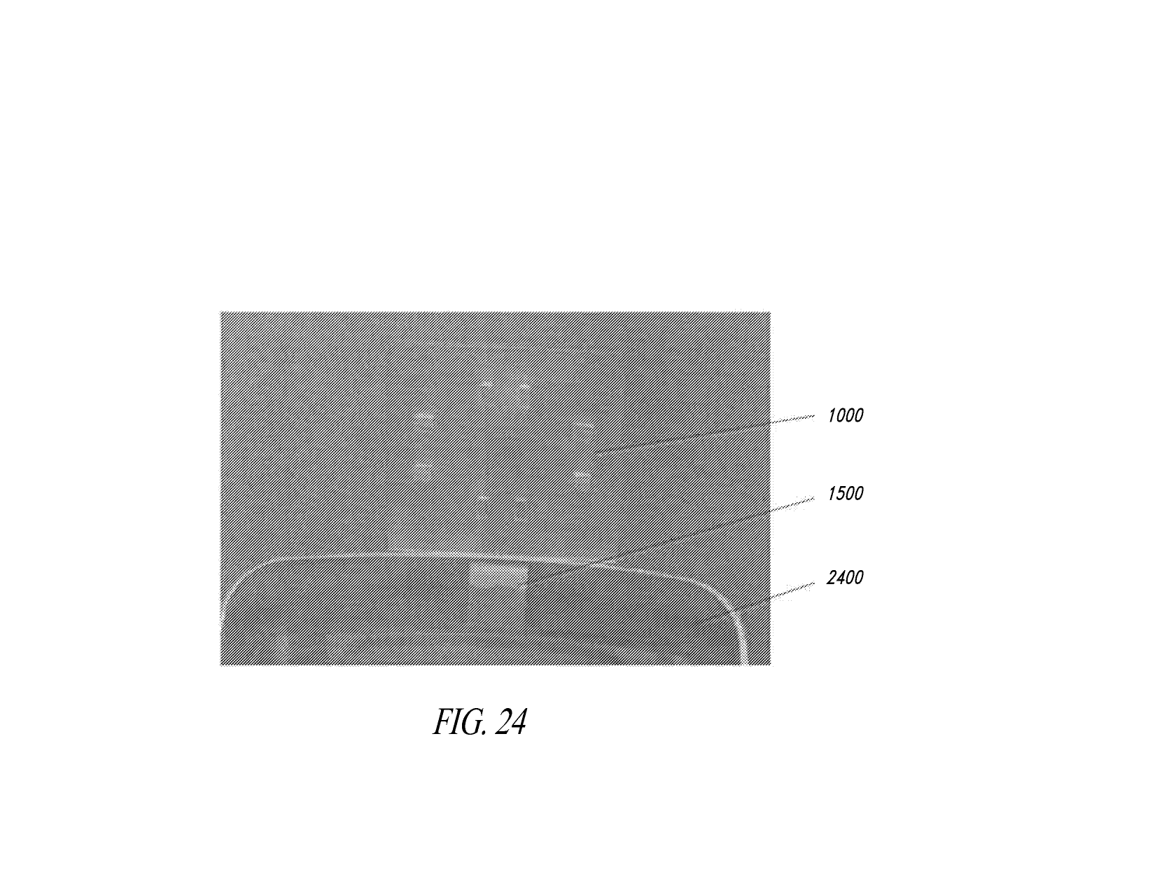

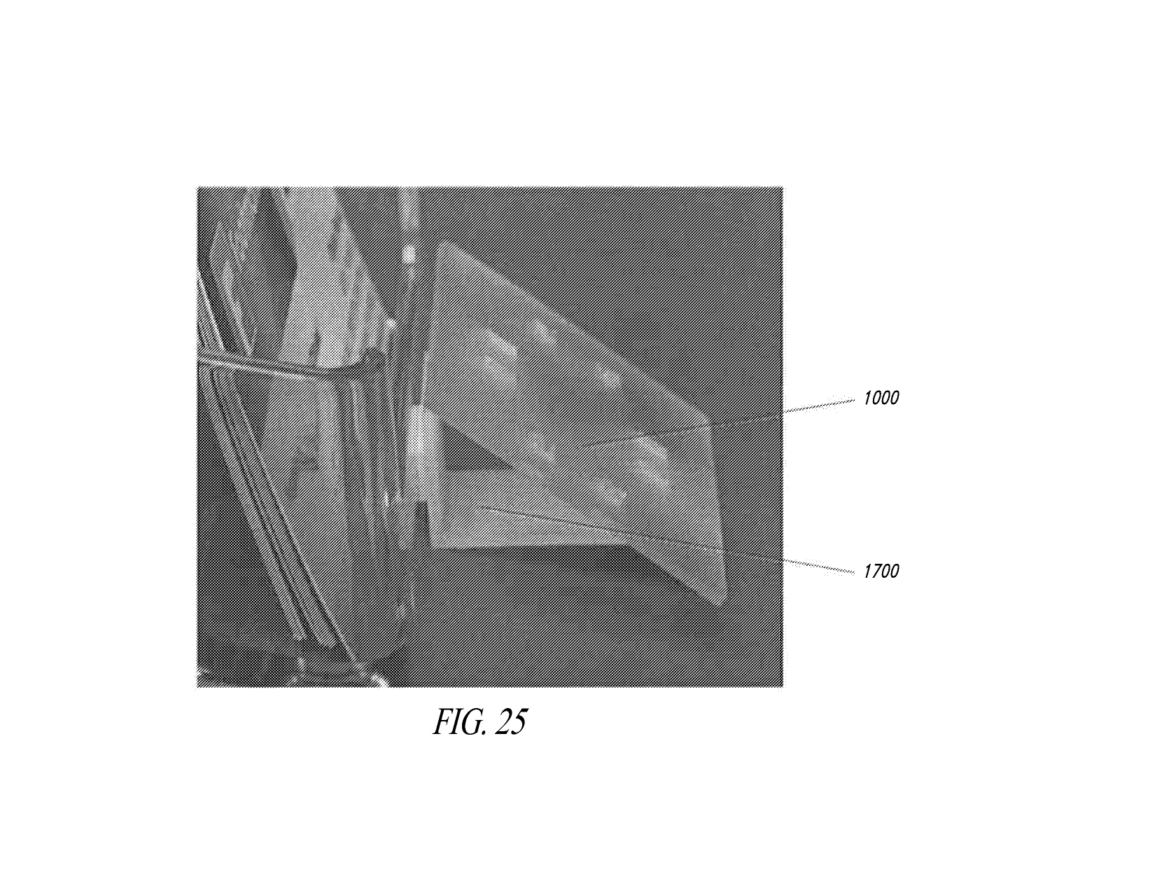

FIGS. 25 and 26 are similar to FIGS. 21 and 22, respectively, except that the pad 1000 is being deployed, instead of the pad 9000. In FIGS. 25 and 26, the clip 1700 of FIG. 17 is used to mount the pad 1000 on or against the object, in a manner generally similar to what was previously described above with respect to FIGS. 21-22.

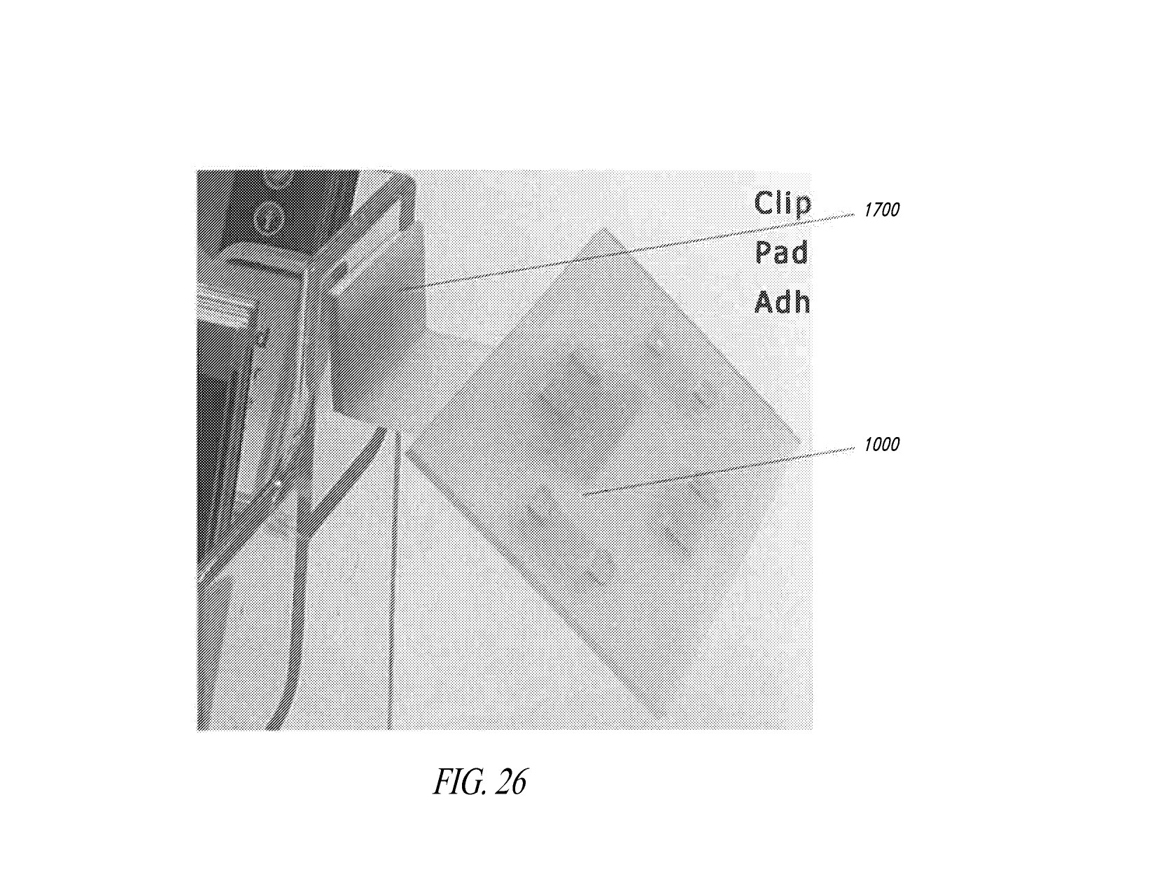

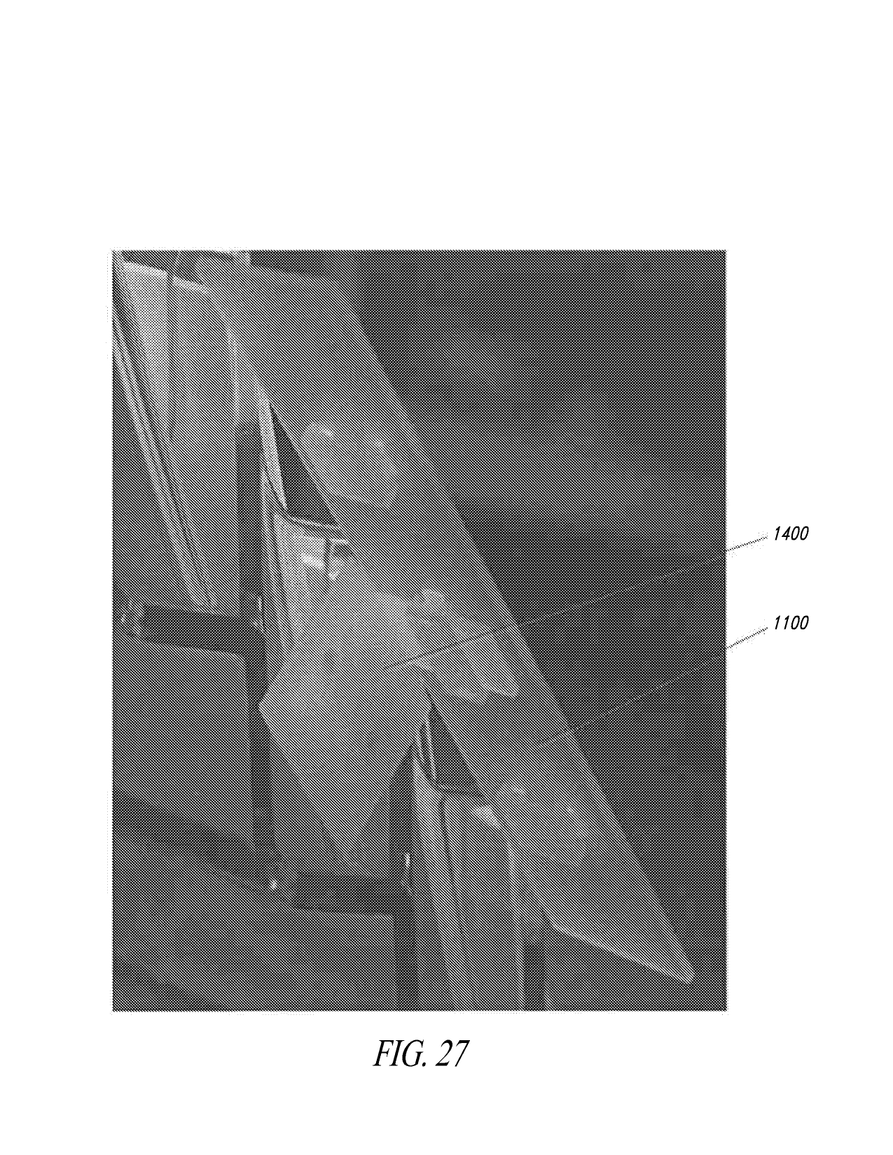

FIGS. 27 and 28 are similar to FIGS. 23 and 24, respectively, except that the pad 1100 is being deployed, instead of the pad 1000. In FIGS. 27 and 28, the pad 1100 is mounted on the object, in a manner generally similar to what was previously described above with respect to FIGS. 23-24.

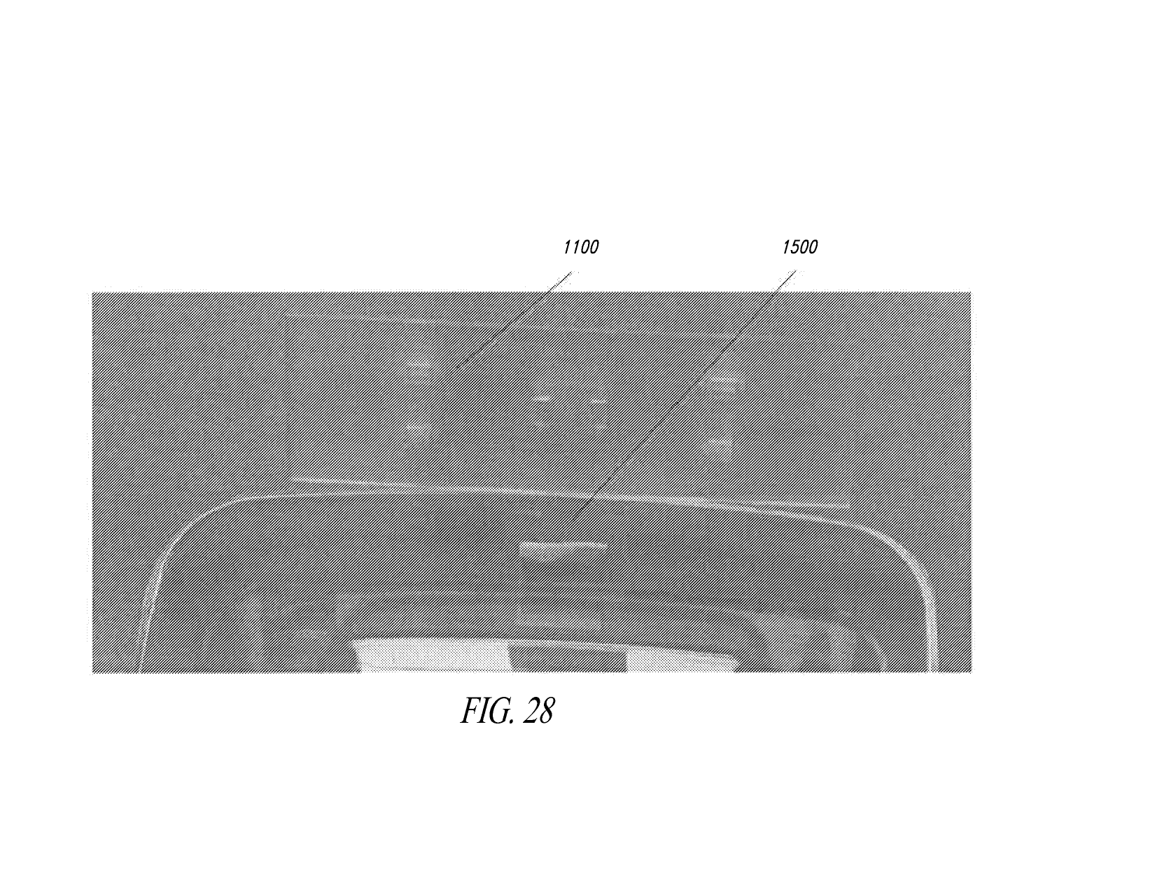

FIG. 29 shows the pad 1100 in a standalone deployment configuration. The clip 1400 is used to provide the support structure, in a manner somewhat similar to what is described above with respect to FIG. 19.

It is understood that the foregoing is just a few of possible deployment configurations. Other deployment configurations are available in other embodiments.

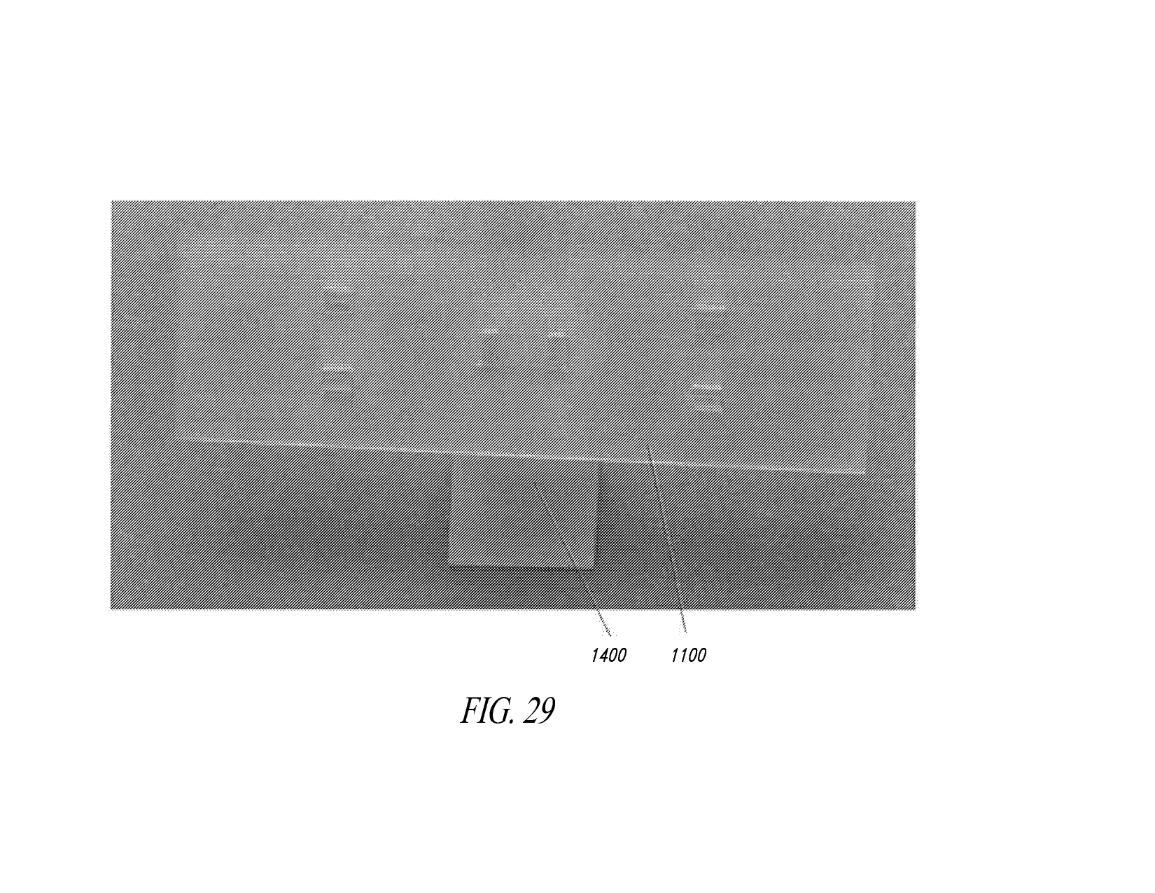

FIG. 30 shows examples of stickers that can be affixed to the various embodiments of the mounting apparatus disclosed herein. A sticker 3000 has a horizontal orientation, while a sticker 3002 has a vertical orientation. In some embodiments, the printed content on the sticker can be in color, grayscale, or combination of both.

A sticker may be adhered to a surface of the pad, such as over the face surface described above. The content of the sticker may include, but not be limited to, branding, QR code(s), and activation code(s) printed on them, as well as a NFC chip(s) embedded in the sticker itself. In the example stickers shown in FIG. 30, each individual sticker includes a QR code, plus one or more trademarks or other branding (including a logo or slogan) located proximate to the QR code. The branding may also include a graphical design aspect, such as in the form of a curved line in shown in FIG. 30 or other graphical element to aid in the recognition and/or aesthetic appearance of the sticker.

The branding may be optional. As explained throughout herewith, the pad has the ability to communicate with a user's mobile device in order to function as intended, and so the pad uses at least one communication method (e.g., Bluetooth, NFC, QR Code, or other wireless technology). An activation code of one embodiment may be a reference ID that is human-readable, thereby allowing for things such as activating the device (e.g., the sticker and/or pad) and referencing the device visually without the need for a smart phone or other user device to read the QR Code or NFC chip. The activation code may also protect against hacking attempts to gain control of a device while the device is being shipped to a customer, as the customer will know what the activation code is in order to take control of the device and associate it with their account. The sticker may be provided with tabs on the sticker so as to wrap around the edges of the pad, and the tabs are used to hide the activation code from line of site when the pad is attached to a business card holder.

One feature provided by various embodiments include, without limitation, the ability for professionals and businesses to present an easy and quick way for their customers and clients to acquire their contact details using a mobile device, smartphone, and the like. One feature provided by presenting the NFC chip, Bluetooth chip, or QR tag next to their business cards is the ability for the consumer to quickly identify the type of information that is available to them by scanning the QR code, connecting to the Bluetooth, or hovering over or tapping the NFC device. If the communication devices were further away from the business cards, some additional signage or written communication may be provided to inform the consumer what data is available to them.

The additional feature of the disclosed embodiment(s) is the linking of the consumer to the employee of the business, which will allow the consumer to easily keep track of the contact details in a remote database and allow them to easily communicate with the employee in the future. Further, the consumer may provide feedback on their experience with the service provided by the professional or business. Further, the consumer may easily be able to forward or share employee contact details with relatives, friends and colleagues. An advantage for the employee is additional referrals and their ability to build a personal contact book of their customers, which may allow them to receive increased sales and may allow them to provide better customer service by staying in contact with the repeat customers.

In one embodiment, a system is provided that allows employees, professionals and businesses to interact and stay in touch with their customers by providing their contact details to their customers in an easy and quick manner.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

The above description of illustrated embodiments, including what is described in the Abstract, is not intended to be exhaustive or to be limited to the precise forms disclosed. While specific embodiments and examples are described herein for illustrative purposes, various equivalent modifications are possible and can be made.

For example, while certain embodiments are depicted as using insertable/removable clip(s) along with bracket(s) and a pad, an embodiment may be provided in which at least the clip and pad are integrated together as a single piece. In such an embodiment, for instance, the clip and pad may be formed as a single piece of plastic, thereby eliminating the need for a bracket.

Furthermore, all of the possible combinations and configurations of the various clips and pads, during deployment, are not explained or shown in detail herein, for the sake of brevity. A person skilled in the art having the benefit of this disclosure would understand the manner in which the various pads and clips may be arranged to provide other deployment configurations that are not specifically illustrated herein.

Still further in some embodiments, the clips can also be used as small pads by themselves, such as by adhering a clip to the business card holder using the narrower extension portion of the clip for attachment (such as via adhesive) to the business card holder, while the wider attachment portion is used to hold a smaller sticker with an NFC chip embedded in it.

Still further in some embodiments, a pad or similar surface (having the information-storage element located proximate thereto) may be molded off or otherwise made part of a business card holder as an “extension” portion, wherein a sticker (or other element having the information-storage element) could be placed proximate to a surface of the extension portion. Thus, the surface could be part of the business card holder itself, such as if the extension and business card holder are integrally formed together as a single molded piece of plastic (or other material). Currently, conventional business card holders are not designed with sufficient space to place a sticker. With one embodiment, the extension portion would extend past the primary profile/structure of the business card holder, so as to facilitate the user “seeing” the extension portion and hovering his/her mobile device over the extension portion.

These and other modifications can be made in light of the above detailed description. The terms used in the following claims should not be construed to be limited to the specific embodiments disclosed in the specification. Rather, the scope(s) of the claims are to be construed in accordance with established doctrines of claim interpretation.

What is claimed is:

1. An apparatus, comprising:
a pad; and
at least one clip coupleable to the pad,
wherein the pad has an information-storage element that is responsive to a wireless signal from a mobile device to provide information stored in the information-storage element to the mobile device,
wherein the pad is attachable by the clip to a holder that contains physical literature that provides at least some of said information in printed form, and
wherein the pad includes a first portion that is inclined at an angle to improve communication between the information-storage element and the mobile device in view of an angle of incidence of the wireless signal on the pad and in view of an orientation of the mobile device as held by a user over the pad.

2. The apparatus of claim 1 wherein the first portion is inclined at the angle such that the wireless signal has a substantially normal angle of incidence on a face surface of the pad.

3. The apparatus of claim 1 wherein the information-storage element includes at least one or more of a near-field communication (NFC) tag, a radio frequency identifier (RFID) tag, a bar code, a QR code, or a Bluetooth device.

4. The apparatus of claim 1 wherein the information-storage element is affixed on a face surface of the pad as a sticker, printed on the face surface of the pad, or integrated within a material of the pad.

5. The apparatus of claim 1, further comprising at least one bracket, and wherein the pad includes at least one bracket receptacle shaped to receive the bracket.

6. The apparatus of claim 7 wherein the clip includes an extension portion and an attachment portion, wherein the extension portion is inserted into the bracket and held against the pad by the bracket, and wherein the attachment portion is attachable to the holder by a fastener element.

7. The apparatus of claim 6 wherein the fastener element includes at least one of double-sided adhesive tape, a magnet, a screw, a bolt, a suction cup, or a spring-loaded clip.

8. The apparatus of claim 6 wherein the bracket has bracket arms that are shaped to be removably engaged into the bracket receptacle, and wherein the bracket arms form a gap that is sized to receive the extension portion of the clip.

9. The apparatus of claim 1 wherein the pad and clip are configurable in a standalone configuration.

10. The apparatus of claim 1 wherein the clip is usable to provide a sticker having an information-storage element.

11. The apparatus of claim 1, further comprising a sticker attachable to the pad and having the information-storage element, the sticker further including at least one of a branding element, a graphical design, or an activation code.

12. An apparatus, comprising:
a pad assembly operable to provide information in response to a wireless signal from a mobile device, the pad assembly including a pad having a face surface that is inclined to improve communication with the wireless signal incident thereon.

13. The apparatus of claim 12 wherein the pad assembly includes a paper document holder integrally formed with an extension portion that has the face surface pad.

14. The apparatus of claim 12 wherein the pad assembly further includes:
a clip coupled to the pad to enable the pad to be attached to a holder having physical paper-based documents that contain at least some of same said information in printed form; and
an information-storage element located proximate to the pad and containing said information provided in response to the wireless signal from the mobile device.

15. The apparatus of claim 14 wherein the information-storage element includes at least one or more of a near-field communication (NFC) tag, a radio frequency identifier (RFID) tag, a bar code, a QR code, or a Bluetooth device, and wherein the information-storage element is affixed on the face surface of the pad as a sticker, printed on the face surface of the pad, or integrated within a material of the pad.

16. The apparatus of claim 12 wherein the pad includes a plurality of bracket receptacles shaped to receive at least one of a plurality of clips, and wherein the clips have different shapes such that a particular clip may be received into a particular bracket receptacle so as to provide a different deployment configuration for the pad assembly, wherein different deployment configurations are selectable according to the particular clip and bracket receptacle that is chosen so as to provide different angles of incline for the face surface of the pad.

17. The apparatus of claim 12 wherein the information provided by the pad assembly includes business card information or brochure information.

18. A method, comprising:
placing an information-storage element proximate to a face surface of a pad;
deploying the pad in a configuration in which the face surface is inclined so as to improve wireless communication between the information-storage element and a mobile device that sends a wireless signal that is incident on the face surface; and
in response to the wireless signal incident on the face surface, providing information stored in the information-storage element to the mobile device.

19. The method of claim 18 wherein said deploying includes attaching the pad to a holder that holds paper-based documents having same said information in printed form.

20. The method of claim 18 wherein said deploying includes inserting one of a plurality of different clips into one of a plurality of bracket receptacles of the pad, and wherein an angle of incline of the face surface and a deployment configuration of the pad can be varied according to a particular clip and a particular bracket receptacle that is selected.
